(19) United States
(12) Patent Application Publication
(10) Pub. No.: US 2007/0119838 A1
(43) Pub. Date: May 31, 2007

(54) Novel connecting piece of electrically conducting material preferably a cable terminal and a mehtod of producing the same

(76) Inventor: Ola Pettersen, Lund (SE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/556,704

(22) PCT Filed: May 12, 2004
(86) PCT No.: PCT/SE04/00726

§ 371 Date: Feb. 13, 2007

(30) Foreign Application Priority Data
May 12, 2003 (SE) 0301391.9

(51) Int. Cl. B23K 1/00

(52) U.S. Cl. 219/129; 219/56.22

(57) ABSTRACT

The present invention (FIG. 2) relates to a connecting piece (4) of metal or other electrically conductive material, preferably a cable shoe, and methods of its manufacture, where a brazing block (11) consisting of a front portion (8), a middle portion (9) and an end portion (10) through combination with other parts and processing can form different connecting pieces (4), which are used in a martensite-free brazing process.

The present invention relates to a completely new method of producing a completely new type of connecting piece of metal or other electrically conductive material, preferably a cable shoe, which is to be joined with another object of metal or other electrically conductive material by brazing where heat is added by way of an electric arc, without the development of structural changes (formation of martensite) under the braze joint. The invention also includes this connecting piece, preferably a cable shoe, holder or connection device of metal or other electrically conductive material.

Until today, martensite formation has been minimised through a method of pin brazing described in Swedish patent 9003708-6 (469 319), as well as eliminated in a brazing process with a connecting piece described in Swedish patent 0101689-8 (518 383).

The disadvantage of existing systems has been the brazed attachment of thick connections with large-diameter cable or thread. The great mass of these thick connections requires more heat to melt the filler metal while heat disappears out into stock and large-diameter cable. It has then been necessary to increase the energy supplied to the brazing process, which has led to a greater risk of excessive temperature in the workpiece, particularly railway rails. An increased energy feed has led to the situation where the material that has caused the heat losses in the heating process has had its own temperature raised, which has entailed increased heat conductivity as a characteristic of this material, thus causing a greater heat-loss effect. The time spent on brazing with thick connections becomes too long.

Furthermore, there have been problems in the martensite-free brazing process when the carbon powder released from the carbon electrode and settling on, for example, the cable shoe, comes loose from the surface and interferes with the electric arc, extinguishing it by way of a short circuit preventing the brazing of the connecting piece from being completed.

A further disadvantage has been that the brazing clip located on the connecting piece has been inclined to come loose because of its protruding parts. Transports and handling by the operator during operation have caused problems.

Another annoying detail has been the flux between the connecting piece and the brazing clip, which is an undesired element from a production point of view.

Another technical detail relating to production has been that previous connecting pieces, cable shoes, have been comprised of pipes in which a cable or thread has been inserted and which have then been pressed together. The interior diameter of the pipe must be adapted to the cross-section area of the cable, consisting of cable material and air space between included cable threads. The relatively great amount of additional material from the pipe together with material flux during the pressing process have resulted in the connecting piece becoming too large and bulky, and having an undesired shape. This has been a problem when large-diameter connections have been needed on the cable.

Furthermore, failed brazings have presented a problem for different reasons, which have caused much extra work in removing the connection for the bad brazing and re-grinding the workpiece.

In addition, the flat surface of the connection members has not been a good heat receptor for a part of the heat produced by the electric arc, thus requiring an increase in the energy feed, which has resulted in an undesired outcome with fewer brazings before recharge of the battery.

The present invention relates to an improvement and a new type of an electrically conductive connecting piece of metal or other electrically conductive material, preferably a cable shoe, which is included in a completely new method for temperature-controlled brazing without the development of martensite.

The invention also relates to a new method for manufacturing this new type of connecting piece of metal or other electrically conductive material, preferably a cable shoe.

An object of the invention is to be able to use a thick, heavy-duty cable shoe with large-diameter cable or thread and the inclusion of this cable shoe in a temperature-controlled brazing process. The desired result is to obtain a brazing which, under the braze joint, is completely free from martensite.

Another object of the invention is to increase the bond strength of the carbon layer on the connecting piece of electrically conductive material, for example, a cable shoe, and to prevent this layer from coming loose in order to obtain a good brazing, without the risk of the electric arc in the brazing process being shut down or short-circuited.

A further object is to simplify manufacturing of connecting pieces of electrically conductive material so that all sizes of cables and, for example, cable shoes will be easily manufactured while also maintaining strength and quality.

Another object has been, in the brazing process thus improved, to be able to reduce the included parts and avoid some steps that are now superfluous thanks to the new brazing process.

A further object has been, by changing the appearance of the connecting piece, for example, a cable shoe by way of knurling and/or blasting and by providing the cable shoe with one or several cavities, to enable a more secure brazing, and by regulating and controlling current and power, to be able to reduce energy, time and material consumption, and to reduce the number of failed brazings.

Furthermore, it is an object to be able to better secure the brazing clip on a connecting piece, for example, a cable shoe, so that it cannot easily be removed from the cable shoe when handled by the operator and during transportation, and to obtain an evenly thick braze joint between the cable shoe and the workpiece when brazing according to the new brazing process.

The characteristics of the present invention will become obvious from the appended claims.

Definitions of terminology, and some examples of connecting pieces:

TABLE 1

| | | | | |
|---|---|---|---|---|
| End portion | Brazing block | | Wearout knob | |
| Middle portion | Filler | Joint part | | |
| Front portion | | | | |
| | | Joint part | | |
| | | Ring | | |
| | | Cable | Cable shoe | |
| | | Welding material | | |
| | | | | Different |
| | | Joint part | Cable shoe | connecting |
| | | Ring | | pieces |
| | | Joint part | Holder | |
| | | Wings | | |
| | | Joint part | | |
| | | Threaded pin | Connection device | |
| | | Joint part | | |
| | | Hook | Clothes hanger | |

The subdivision of the joint part in the first example applies also to the following examples.

The present invention will now be described more closely with reference to the appended drawings, which show a preferred embodiment of the invention.

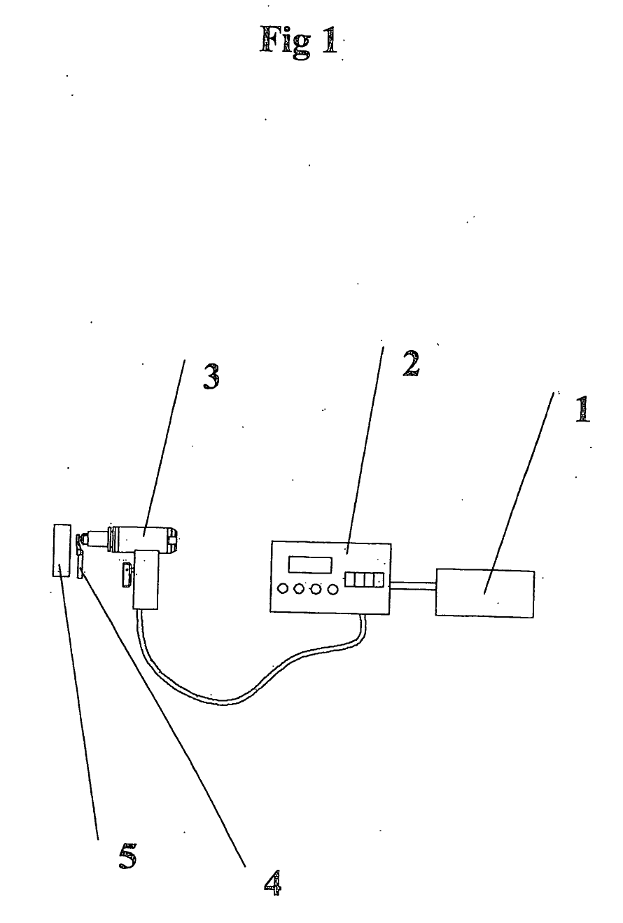

FIG. 1 shows a schematic overview of some of the components included in the brazing process.

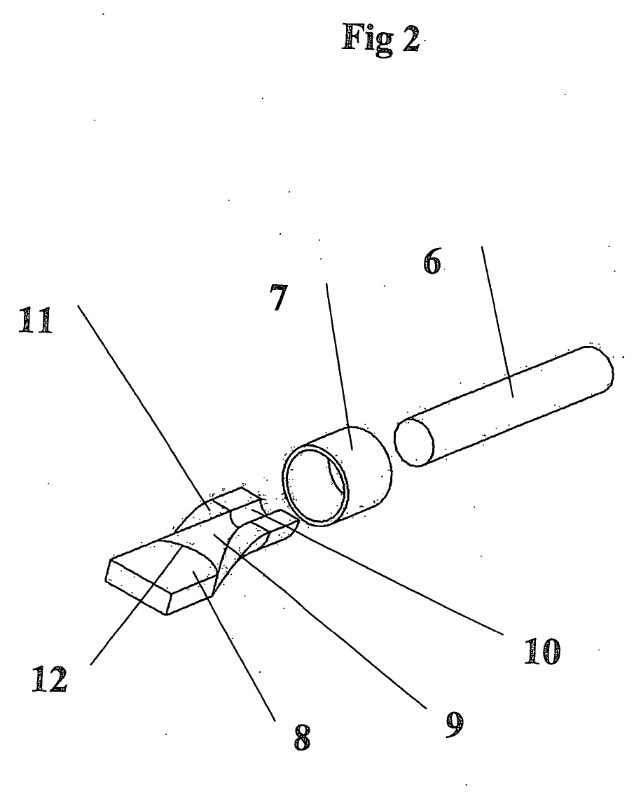

FIG. 2 shows the components included in an electrically conductive connecting piece, excluding the brazing clip.

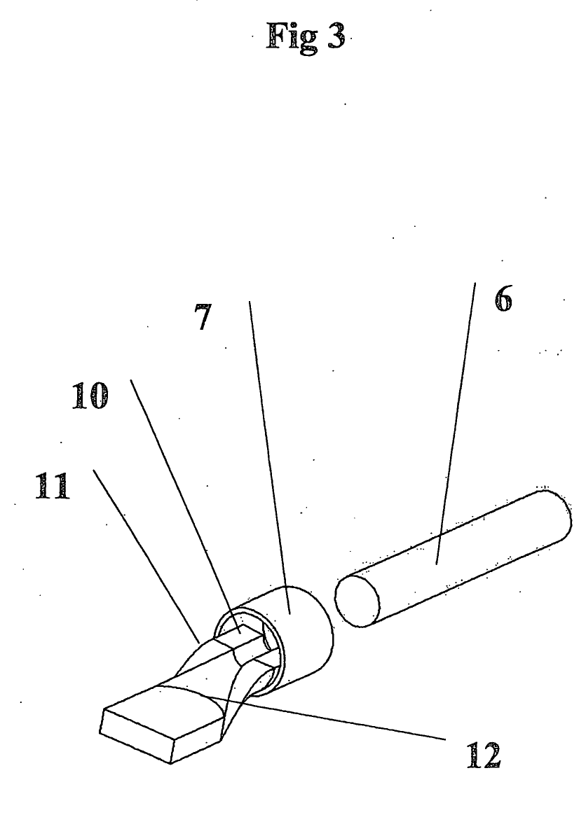

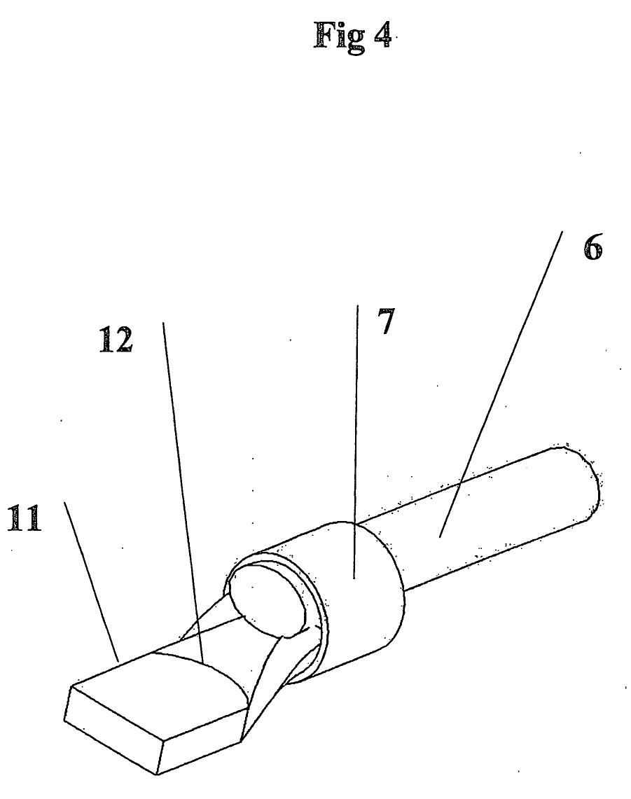

FIG. 3 shows the components included in an electrically conductive connecting piece, excluding the brazing clip, where some are mounted.

FIG. 4 shows the components included in an electrically conductive connecting piece, mounted and excluding the brazing clip.

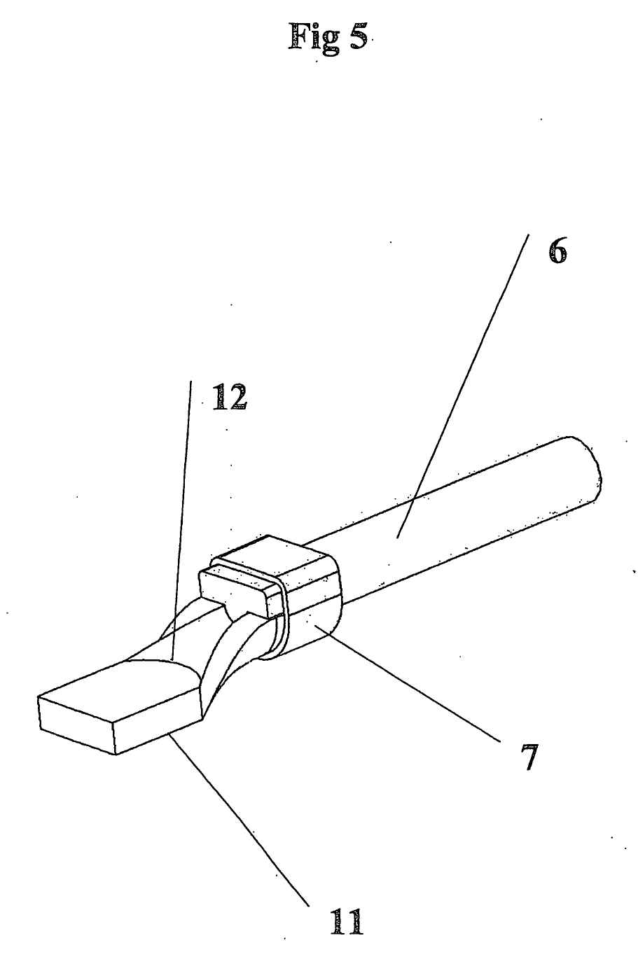

FIG. 5 shows the components included in an electrically conductive connecting piece, mounted, excluding the brazing clip, and where compression has been performed.

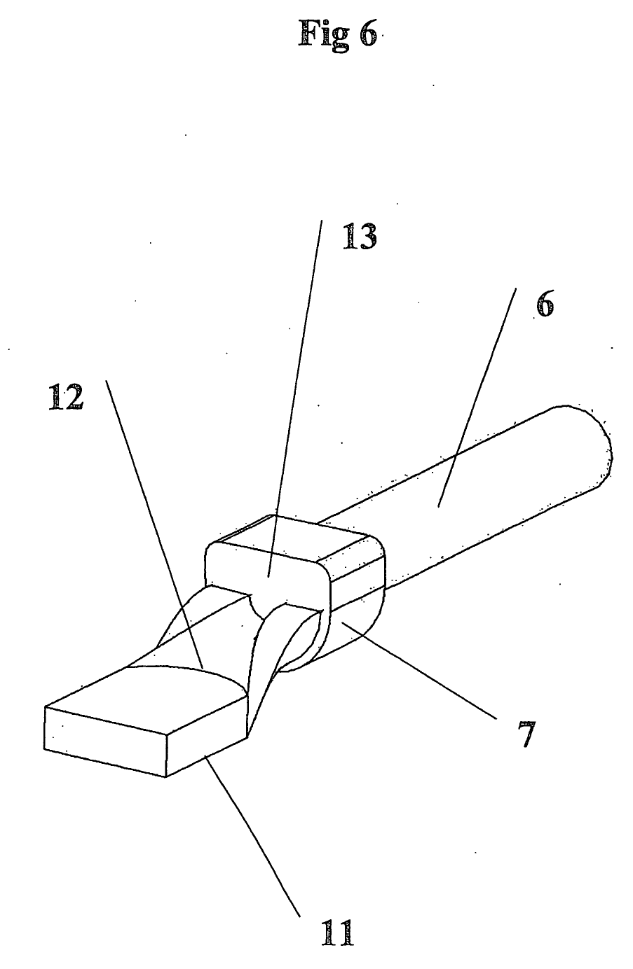

FIG. 6 shows the mounted components included in an electrically conductive connecting piece, on whose compressed portion welding or brazing has been performed, excluding the brazing clip.

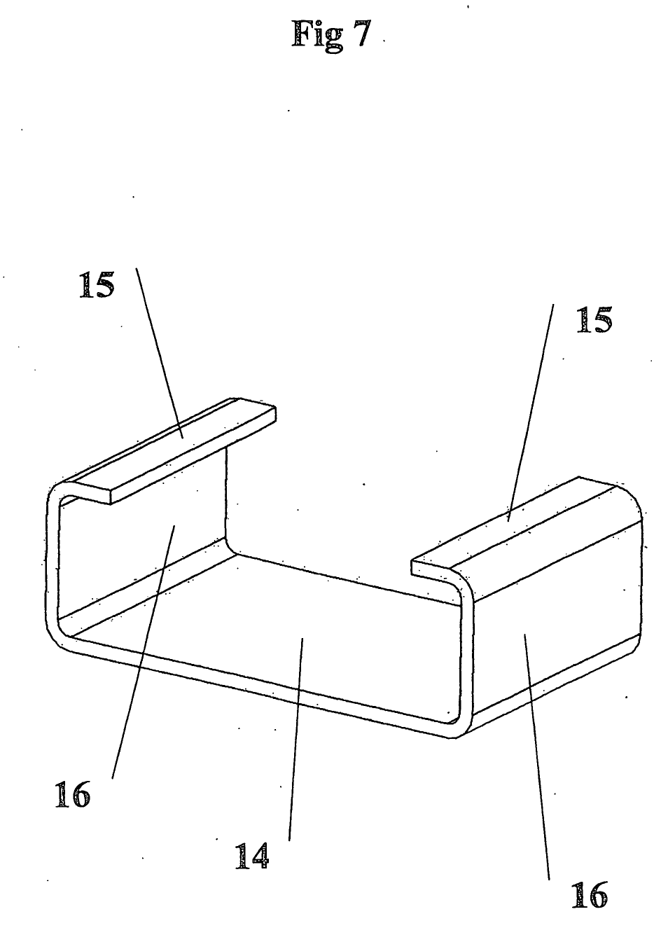

FIG. 7 shows a separately manufactured brazing clip.

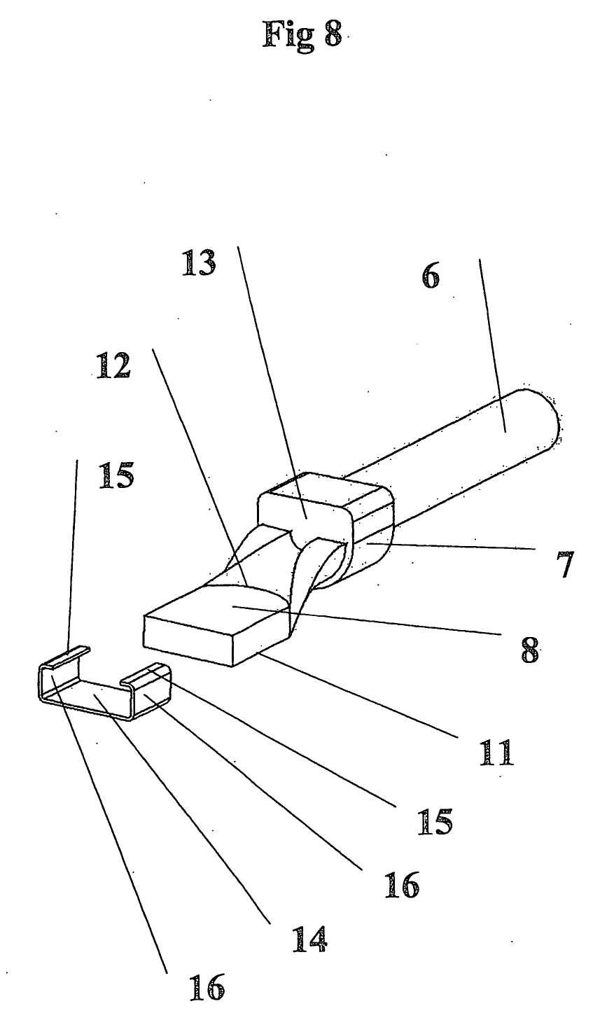

FIG. 8 shows an electrically conductive connecting piece in the form of a cable shoe with an unmounted brazing clip.

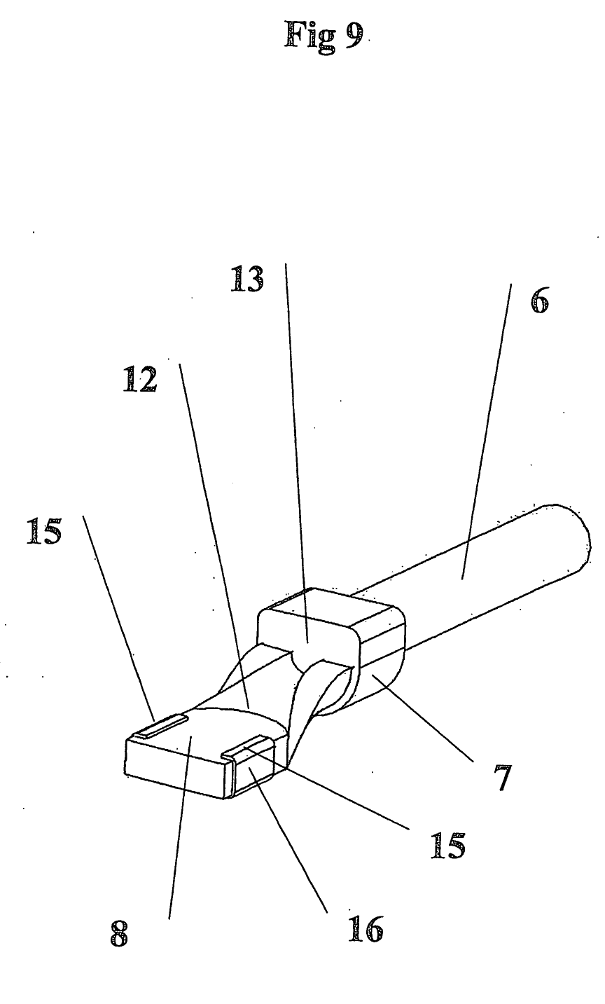

FIG. 9 shows an electrically conductive connecting piece in the form of a cable shoe with a brazing clip slipped onto the front portion of the brazing block.

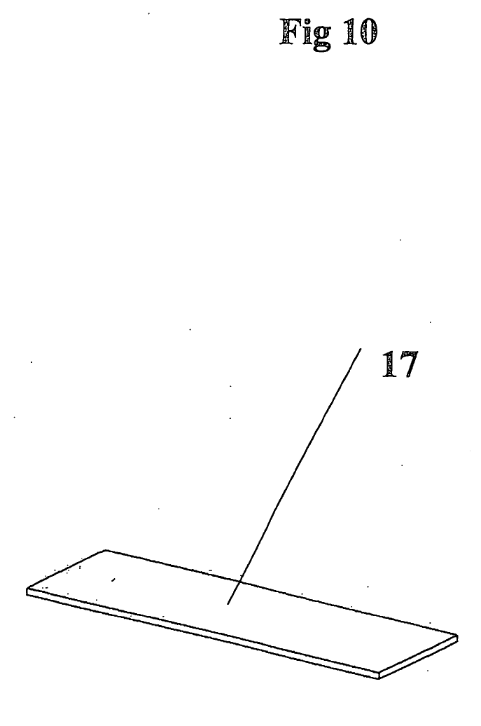

FIG. 10 shows the base material for a brazing clip to be made on a brazing block.

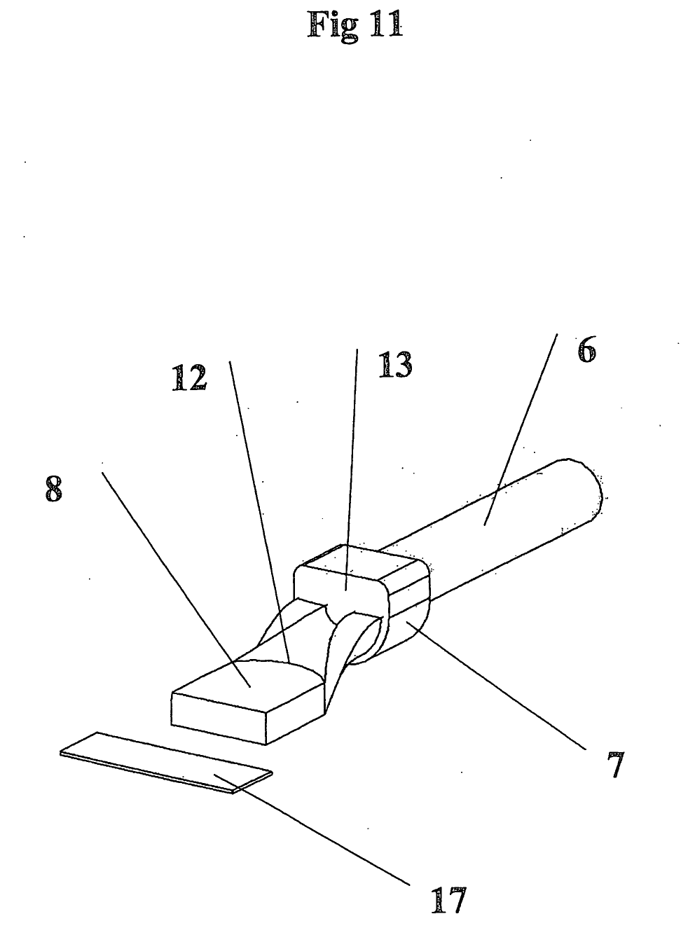

FIG. 11 shows an electrically conductive connecting piece in the form of a cable shoe with a separate base material for manufacturing a brazing clip on the brazing block of the cable shoe.

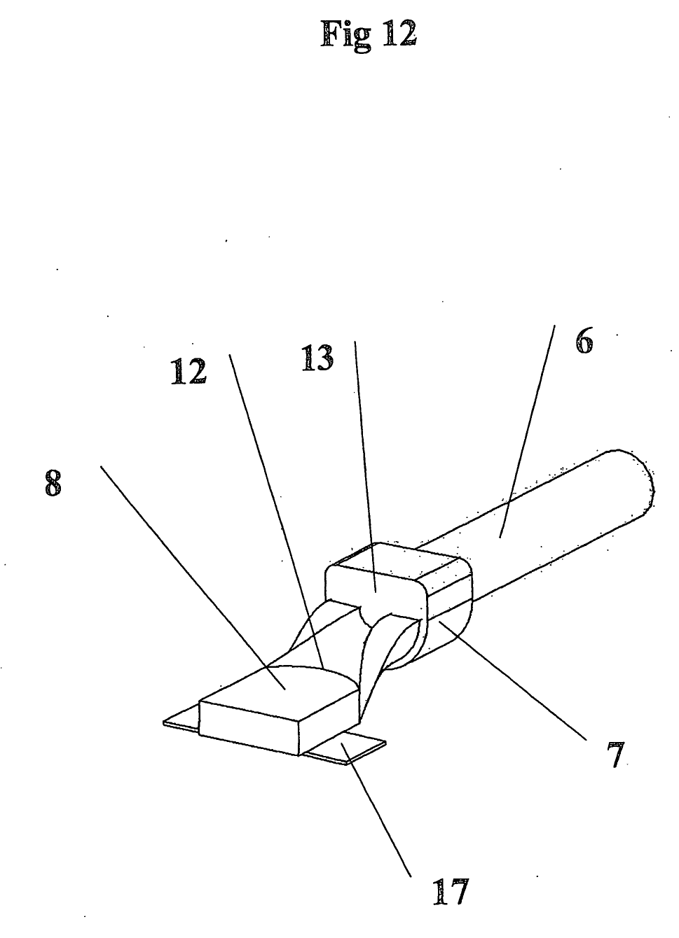

FIG. 12 shows an electrically conductive connecting piece in the form of a cable shoe with a separate base material under the front portion of the brazing block of the cable shoe.

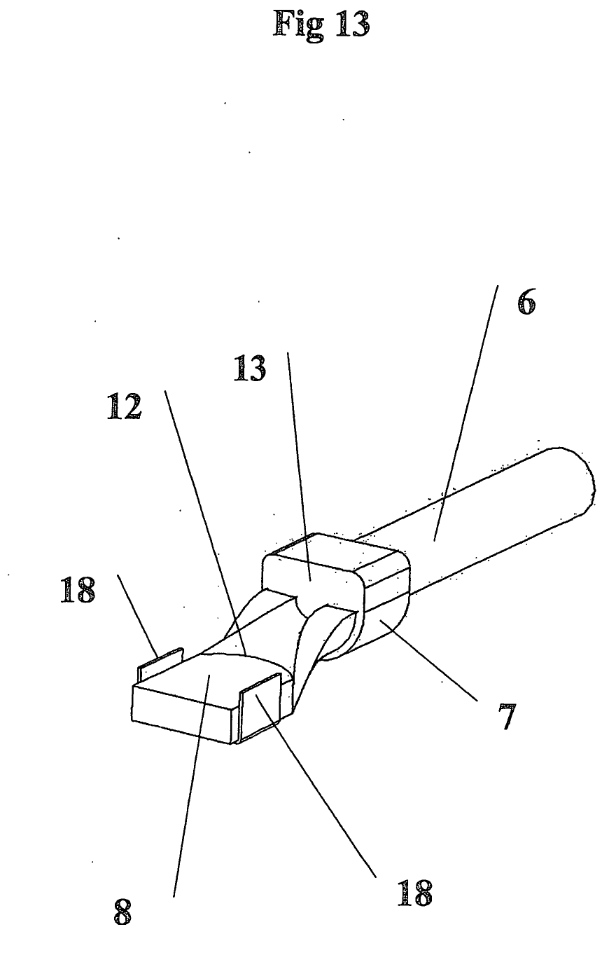

FIG. 13 shows an electrically conductive connecting piece in the form of a cable shoe with a separate base material with folded-up side portions.

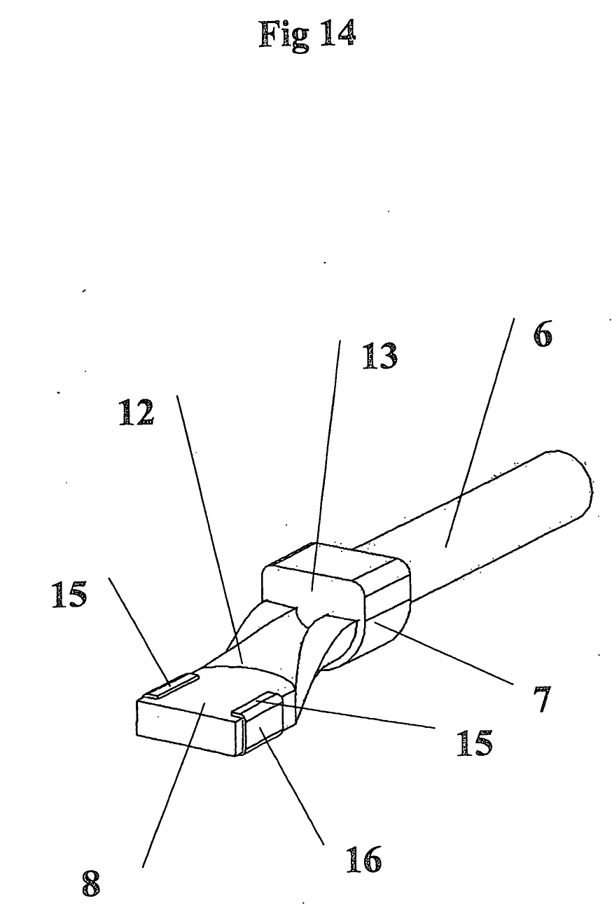

FIG. 14 shows an electrically conductive connecting piece in the form of a cable shoe with a separate base material with folded-up edges and clamping tabs against the front portion of the brazing block of the cable shoe.

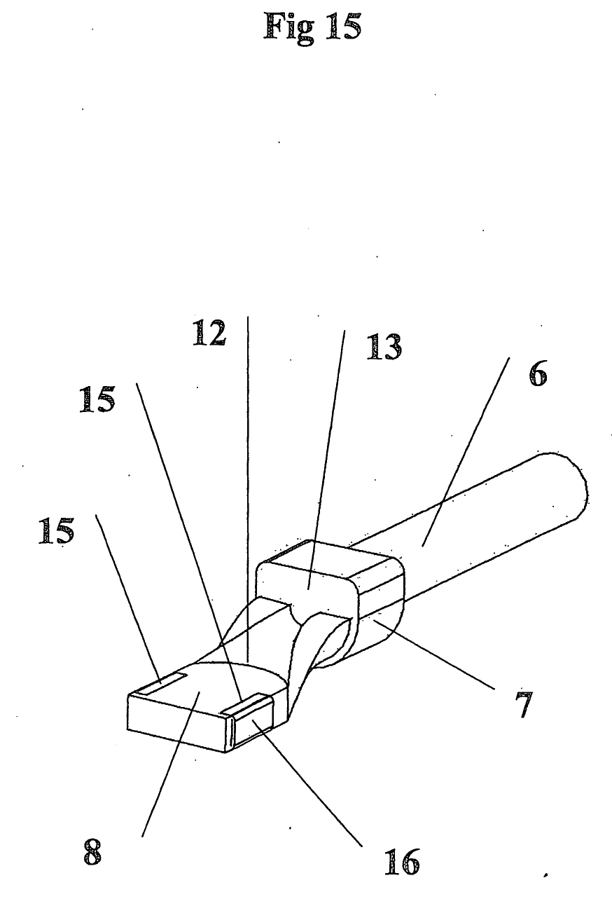

FIG. 15 shows an electrically conductive connecting piece in the form of a cable shoe with a separate base material with folded-up edges and clamping tabs pressed into the front portion of the brazing block of the cable shoe.

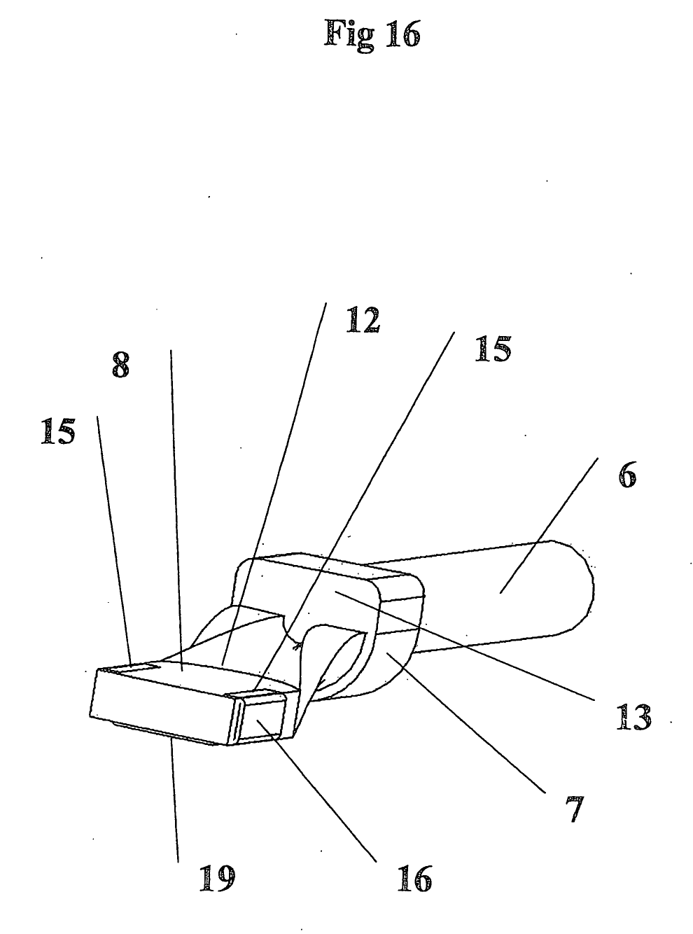

FIG. 16 shows an electrically conductive connecting piece in the form of a cable shoe with a brazing clip with portions located on the surface of the cable shoe and clamping tabs pressed into the front portion of the brazing block of the cable shoe.

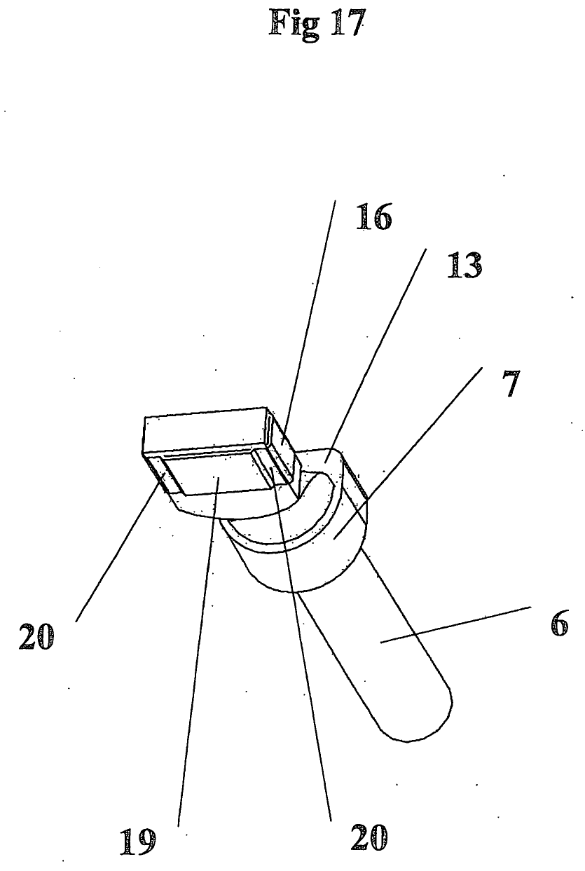

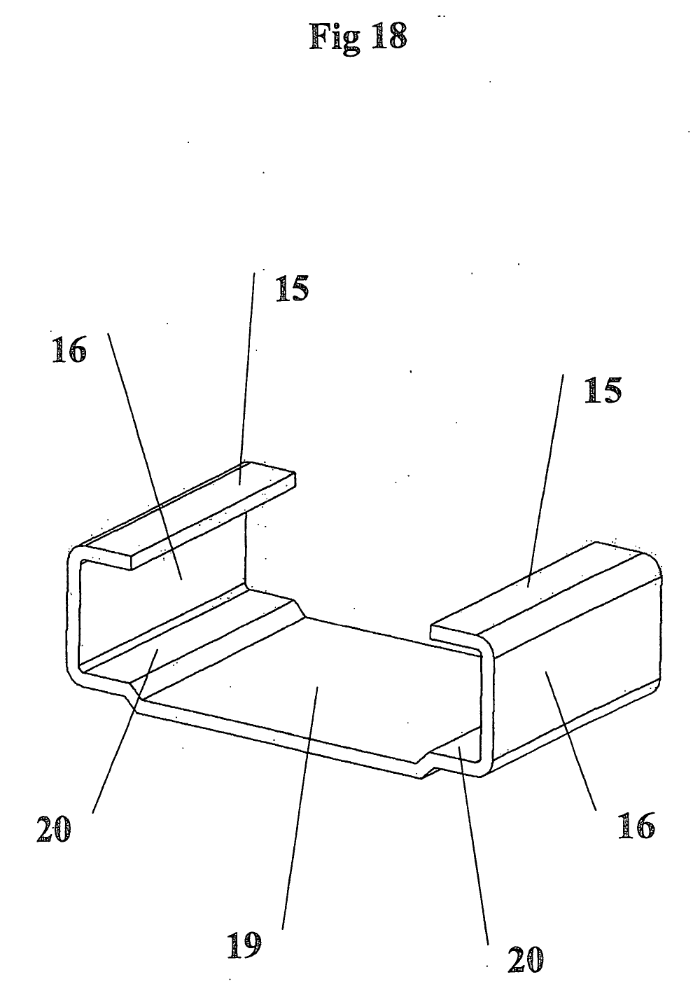

FIG. 17 shows the bottom of an electrically conductive connecting piece in the form of a cable shoe with a pressed-on brazing clip.

FIG. 18 shows the appearance of the completely compressed brazing clip.

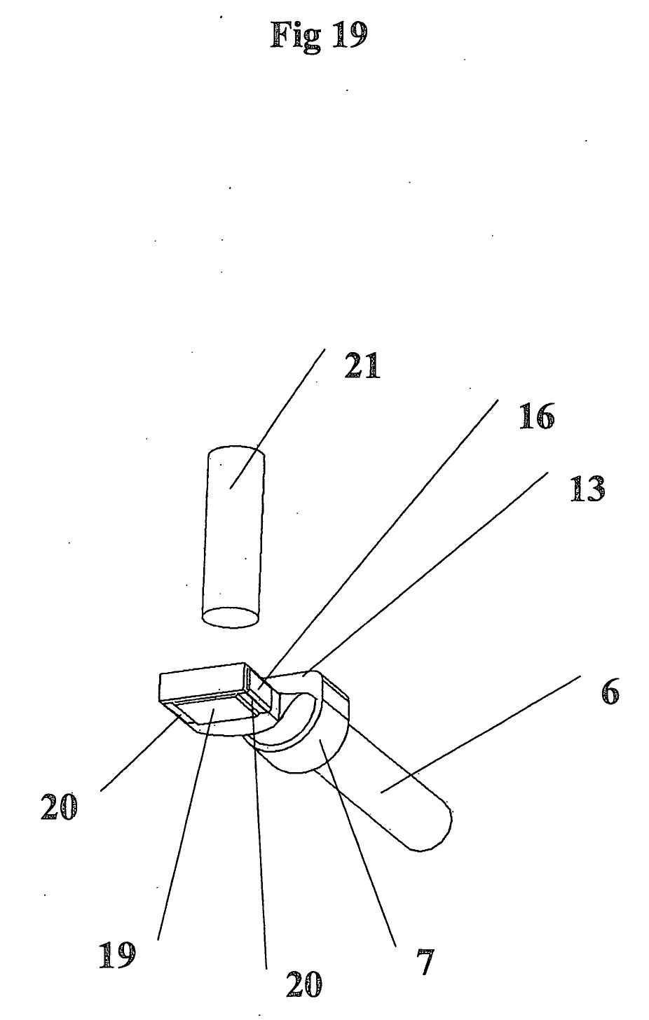

FIG. 19 is a tilted bottom view of an electrically conductive connecting piece in the form of a cable shoe with a brazing clip and an electrode of a brazing gun.

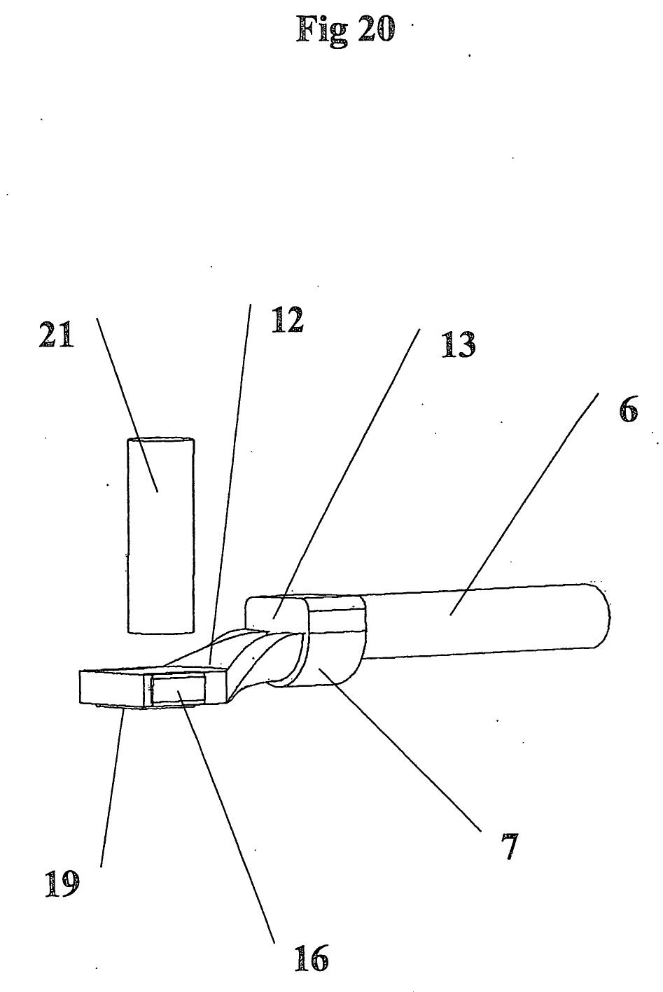

FIG. 20 is an elevational view of an electrically conductive connecting piece in the form of a cable shoe with a brazing clip and an electrode of a brazing gun.

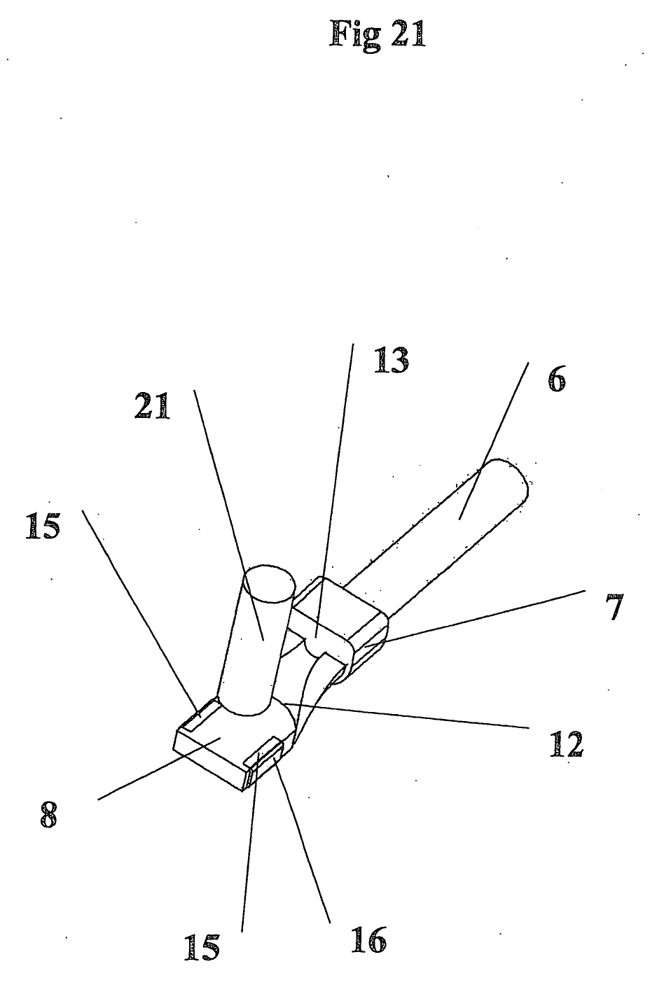

FIG. 21 shows an electrically conductive connecting piece in the form of a cable shoe with a brazing clip and a semicircular raised edge adapted to a guard ring provided in the brazing gun.

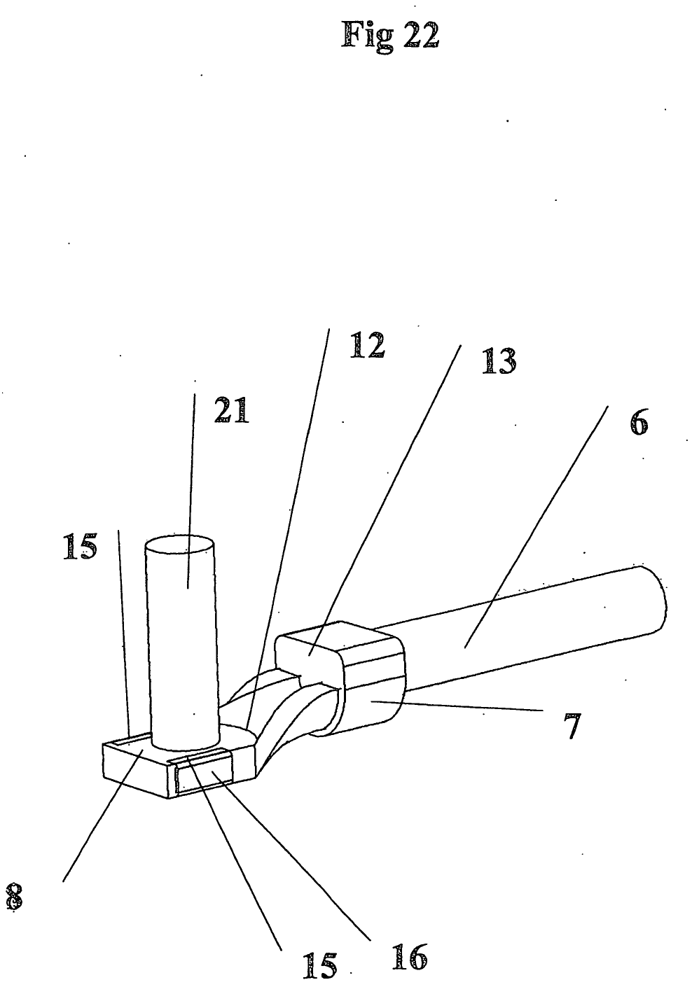

FIG. 22 shows an electrically conductive connecting piece in the form of a cable shoe with a carbon electrode directly against the front portion of the brazing block of the cable shoe.

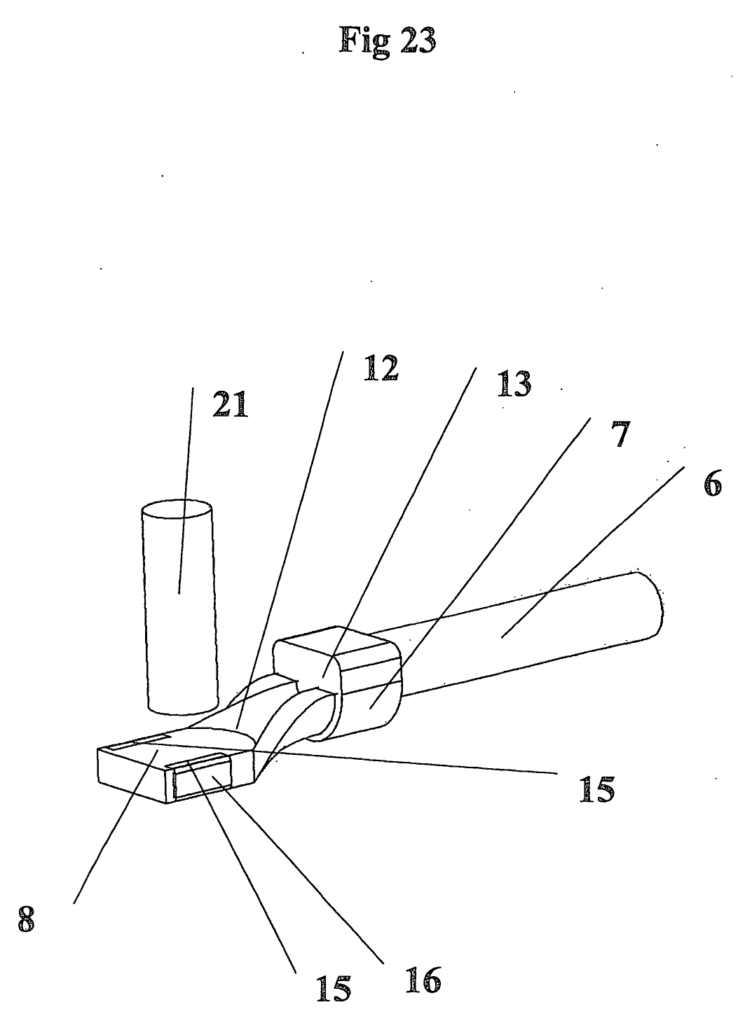

FIG. 23 is a side elevational view of an electrically conductive connecting piece in the form of a cable shoe with a brazing clip and an electrode from a brazing gun and a semicircular raised edge adapted for the guard ring.

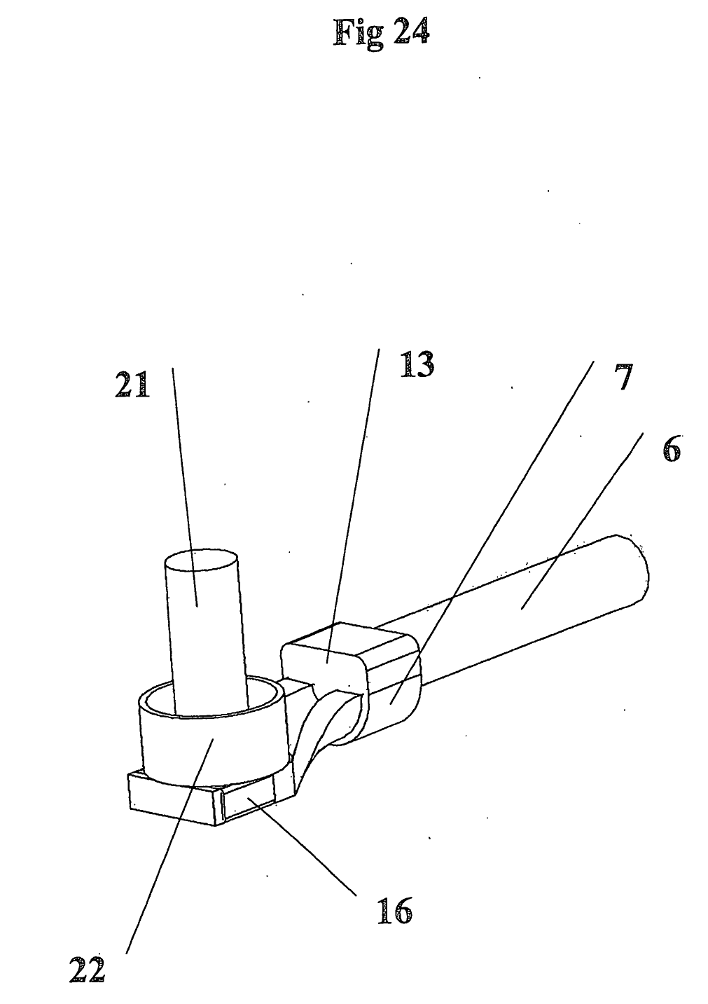

FIG. 24 is a side elevational view of an electrically conductive connecting piece in the form of a cable shoe with a brazing clip and an electrode together with a guard ring from a brazing gun placed against the semicircular raised edge.

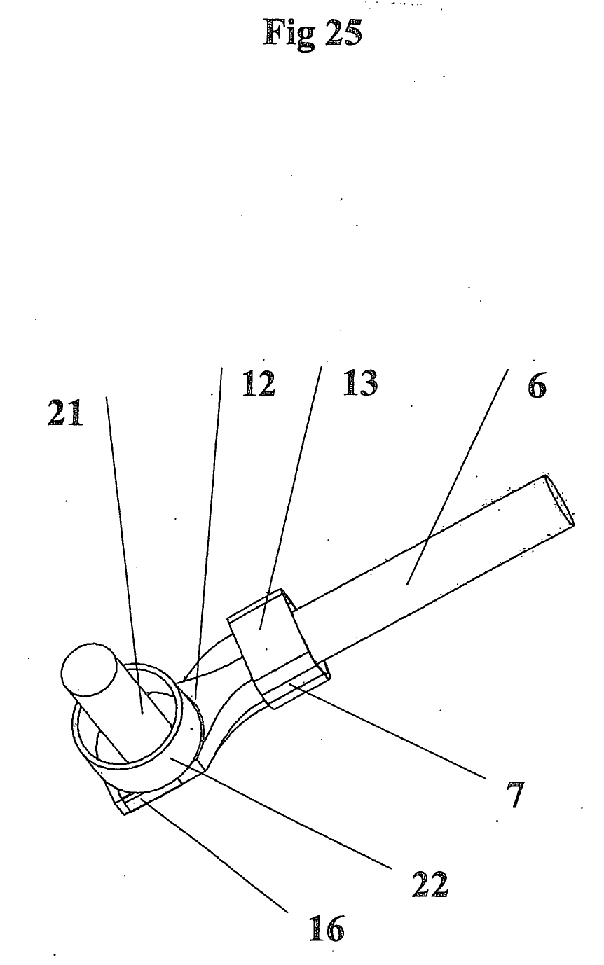

FIG. 25 is a top view of the previous drawing.

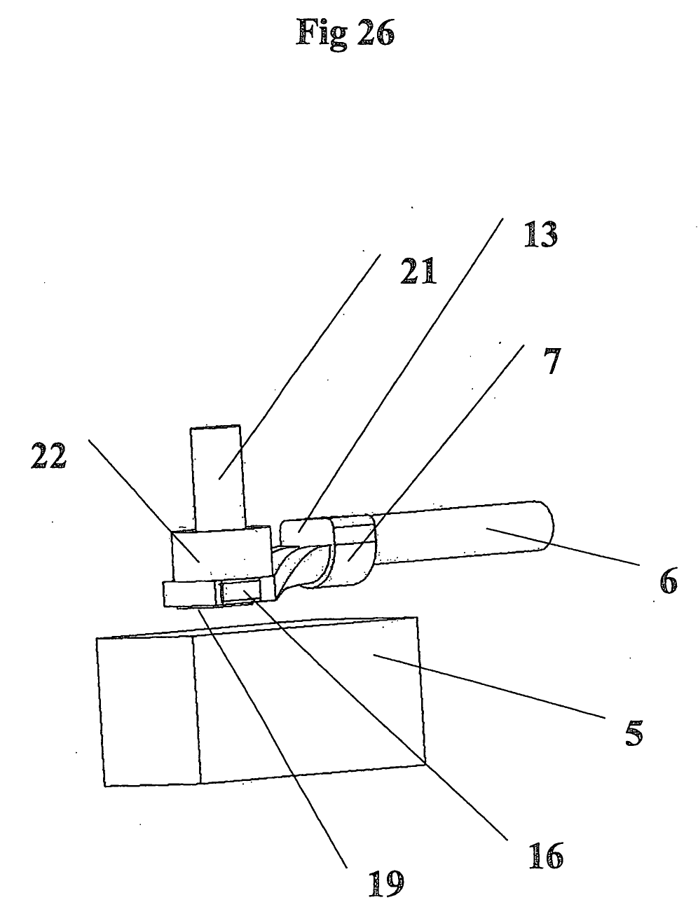

FIG. 26 shows how the electrically conductive connecting piece in the form of a cable shoe is moved towards a workpiece by the brazing gun via a carbon electrode and a guard ring.

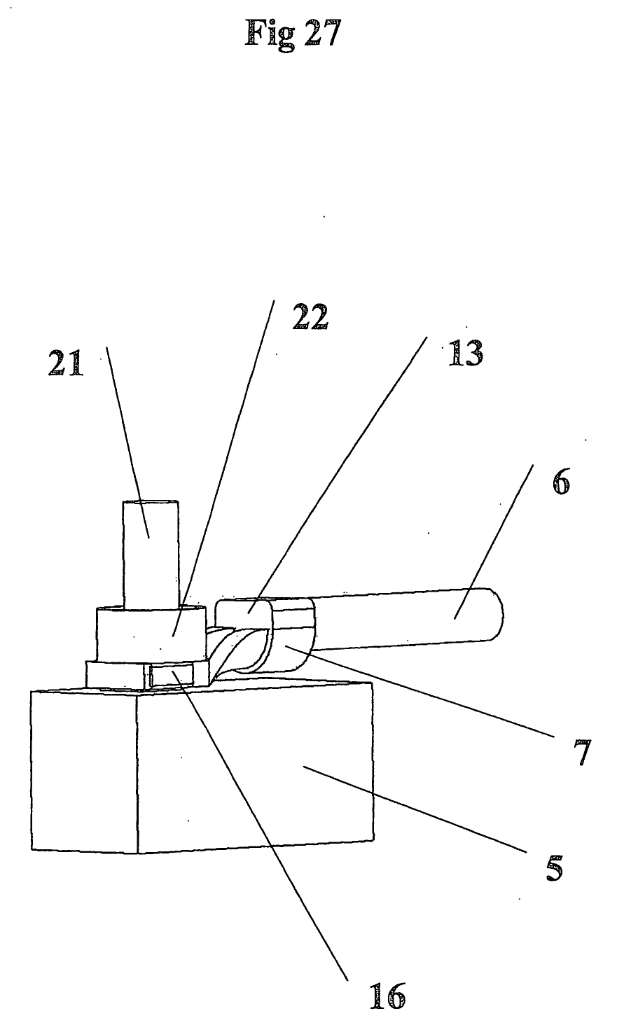

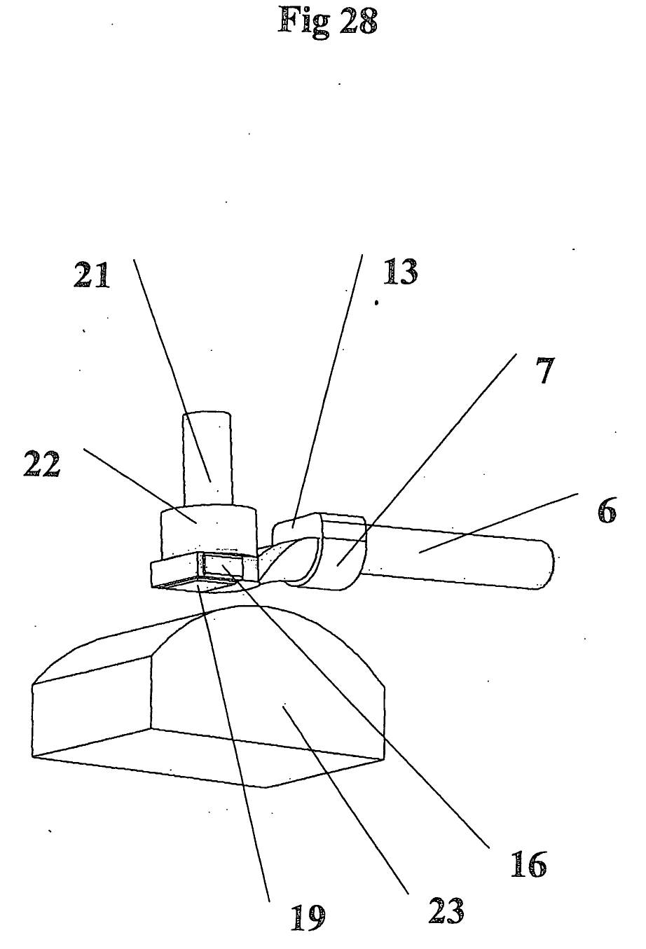

FIG. 27 shows how the carbon electrode and the guard ring which are joined with the brazing gun work on an electrically conductive connecting piece and workpiece.

FIG. 28 shows an electrically conductive connecting piece to be brazed onto a non-planar workpiece.

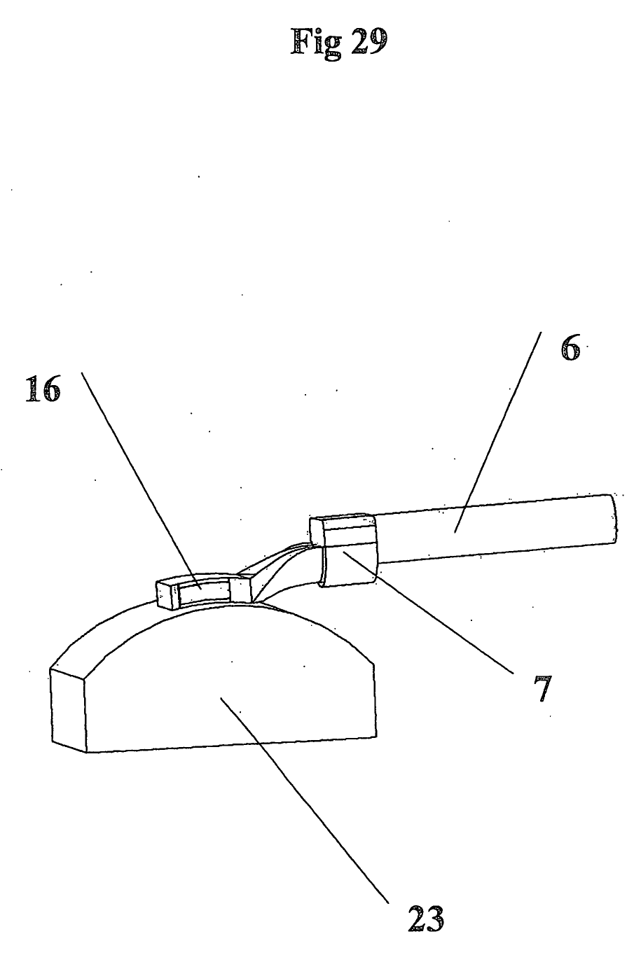

FIG. 29 shows an electrically conductive connecting piece secured onto a non-planar workpiece.

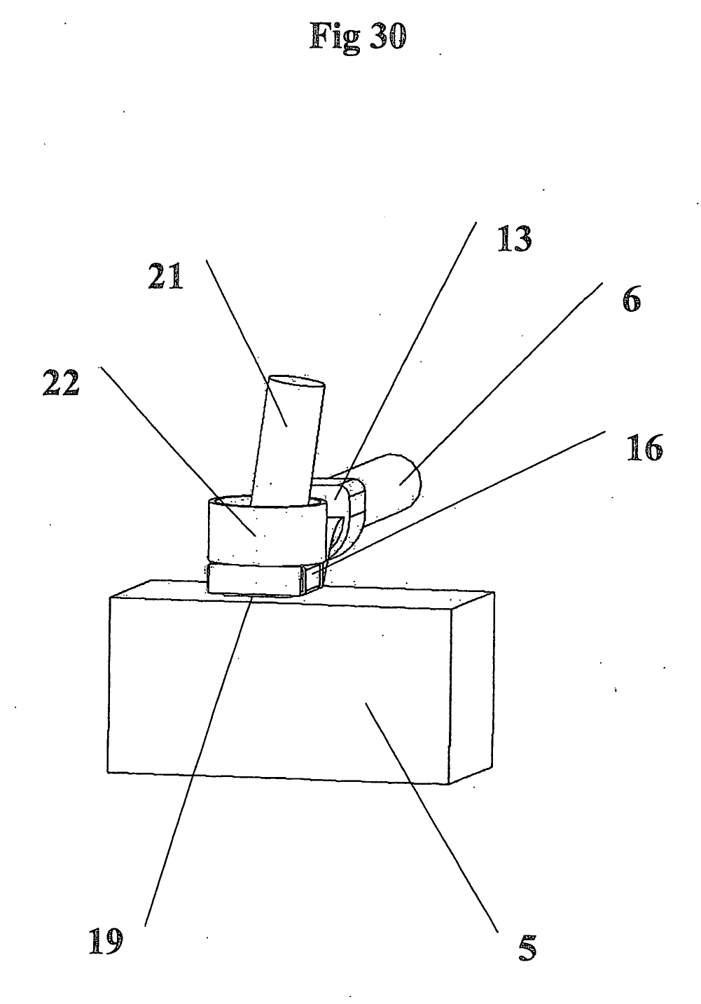

FIG. 30 is a view where the brazing gun does not form a 90-degree angle with the supporting surface.

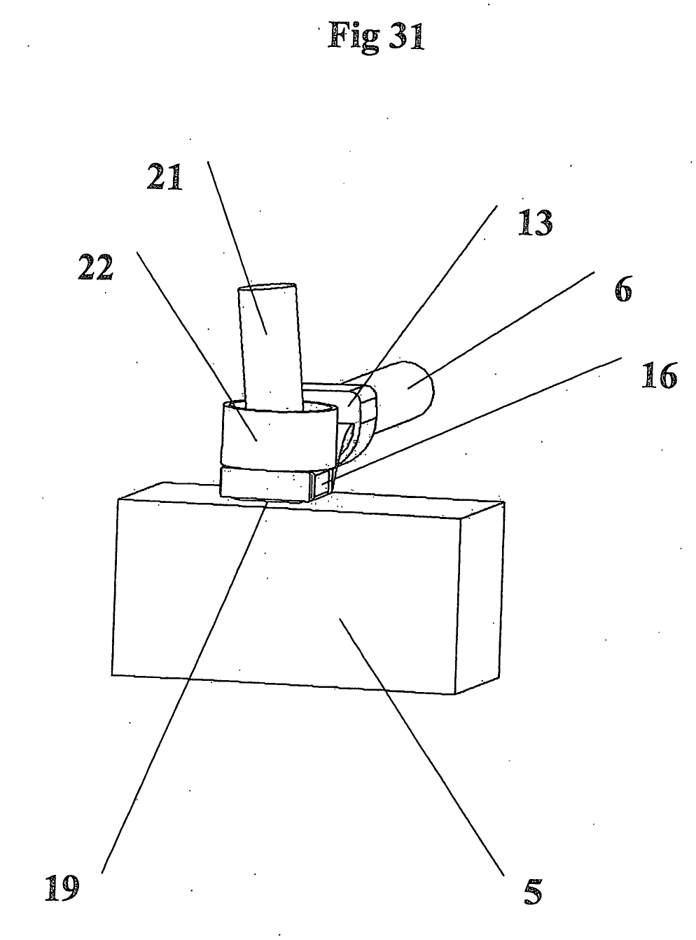

FIG. 31 is the same view but with an angular offset in the other direction.

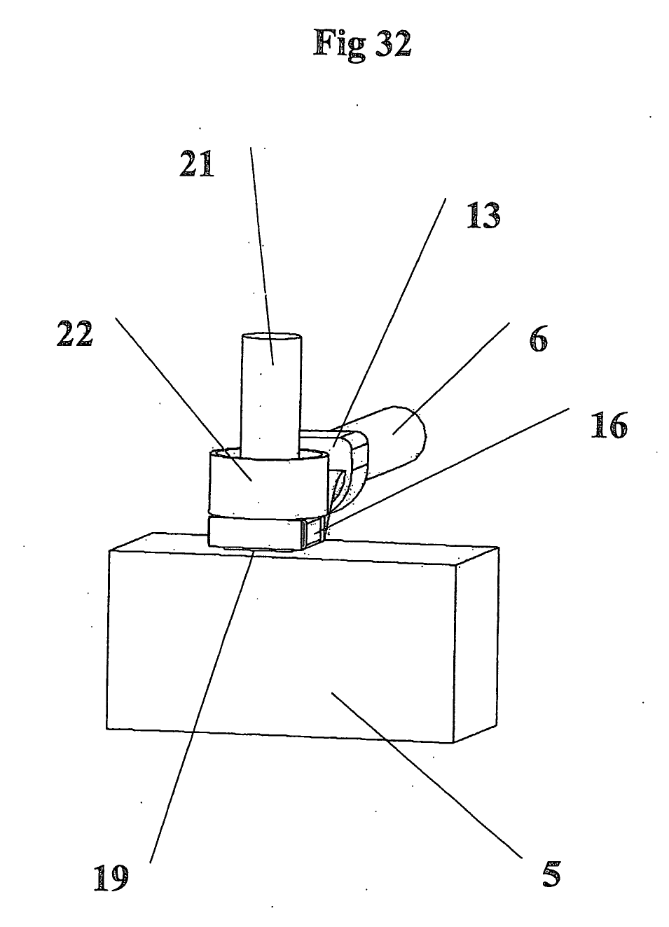

FIG. 32 is also the same view of an electrically conductive connecting piece in a brazing process where the brazing gun has a normal position of 90 degrees.

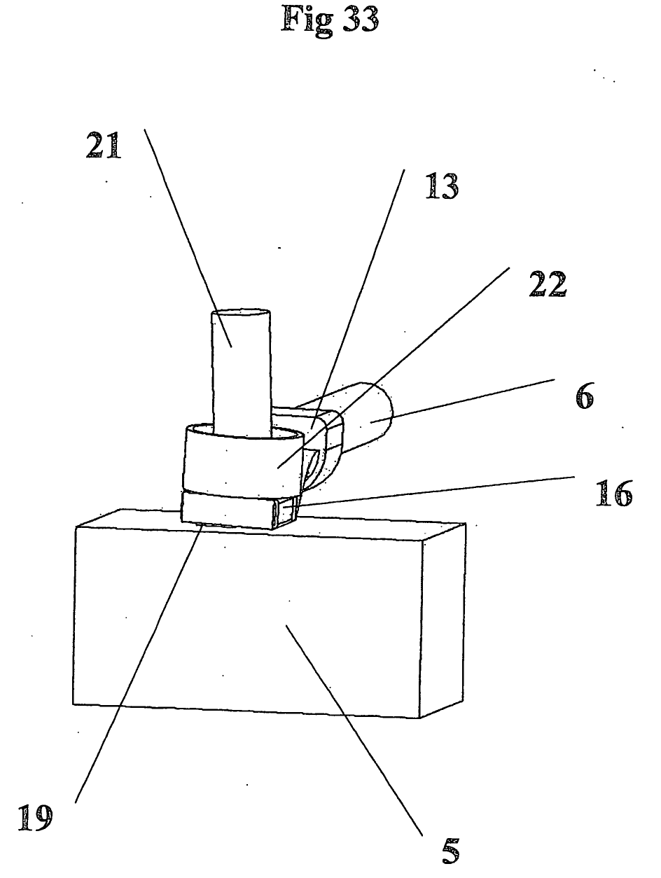

FIG. 33 shows how the filler is melted off asymmetrically during the brazing process.

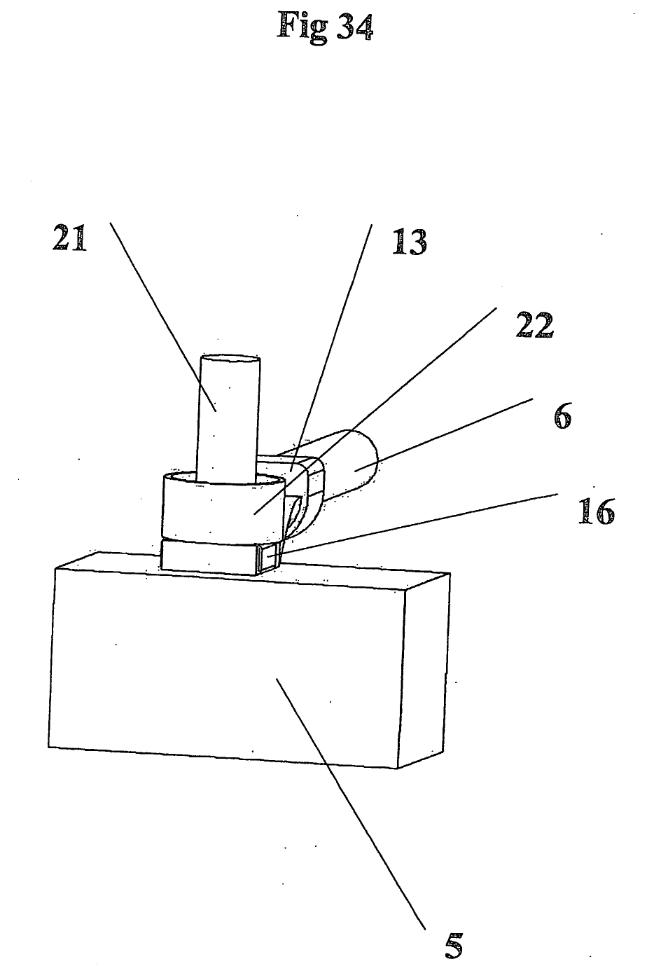

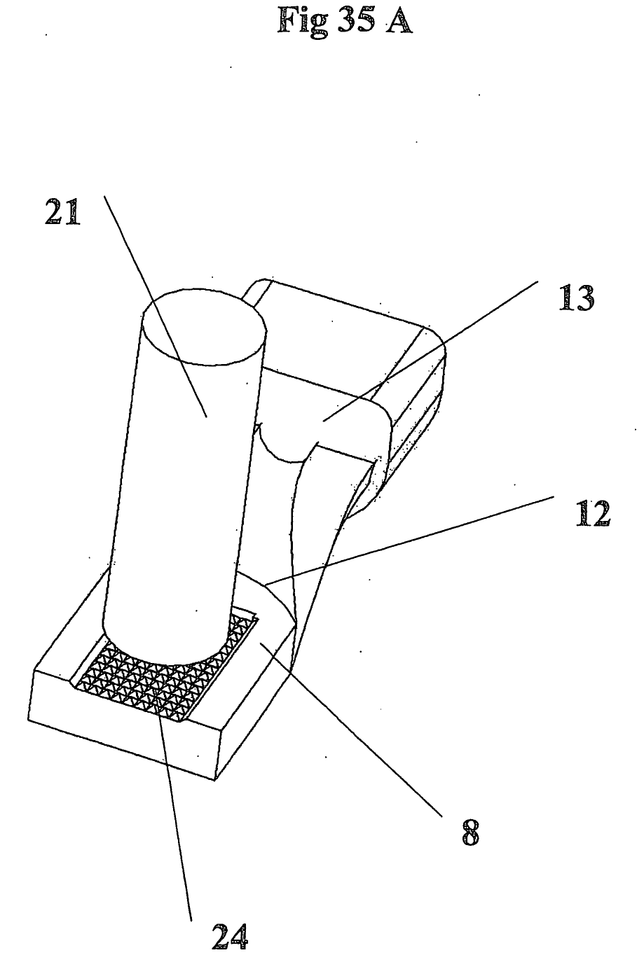

FIG. 34 shows a completed brazing where the filler has melted completely.

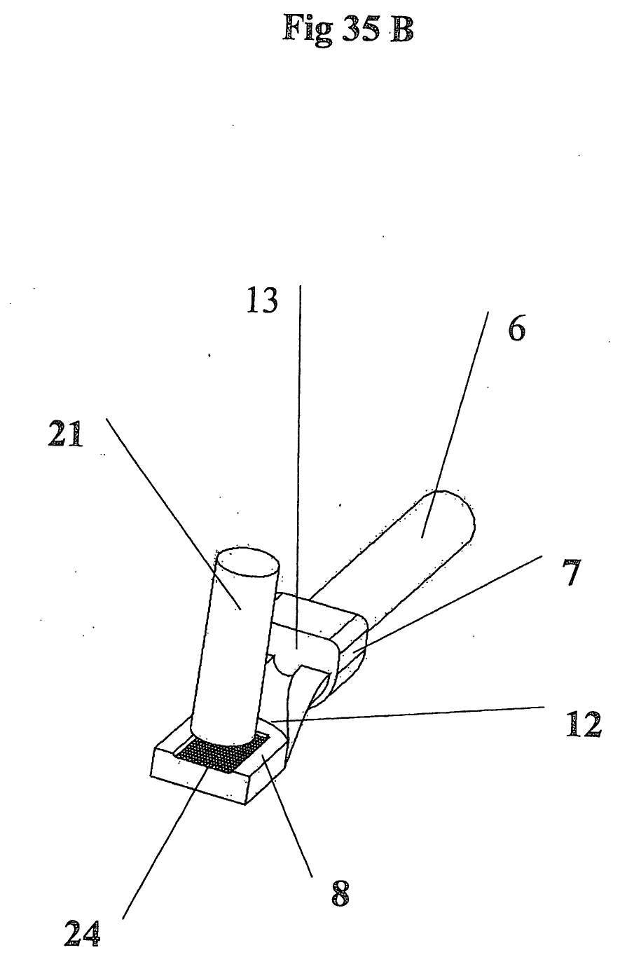

FIG. 35 A shows a knurled connecting piece without brazing clip.

FIG. 35 B shows a knurled connecting piece and a carbon electrode.

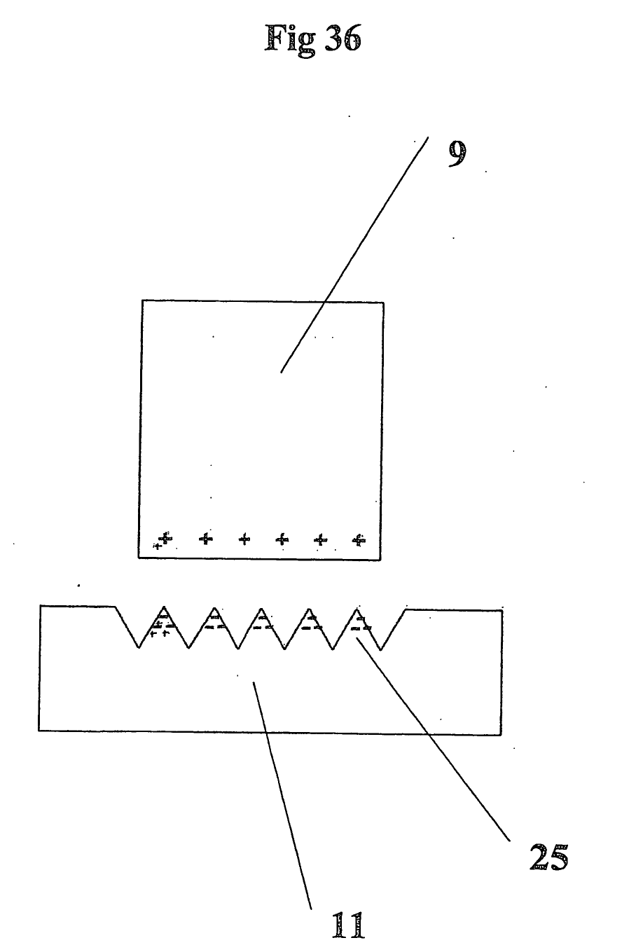

FIG. 36 shows the polarisation of the brazing process in question with a knurled or otherwise superficially modified front portion of the brazing block.

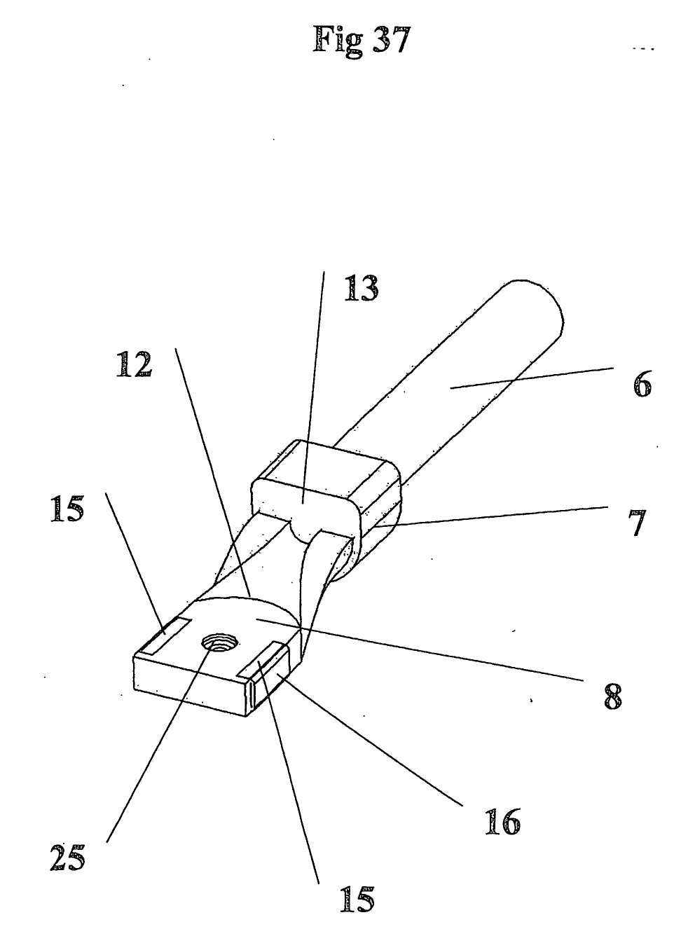

FIG. 37 shows a cable shoe with a cavity on the top surface of the front portion of the brazing block.

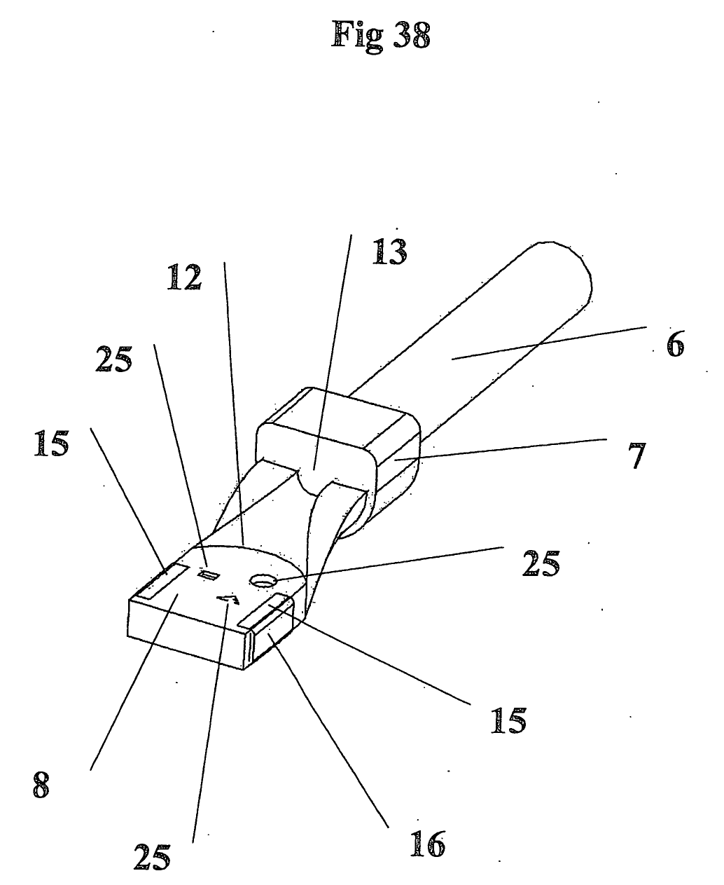

FIG. 38 shows variants of the cavities with respect to shape, number and position on the top surface of the front portion of the brazing block.

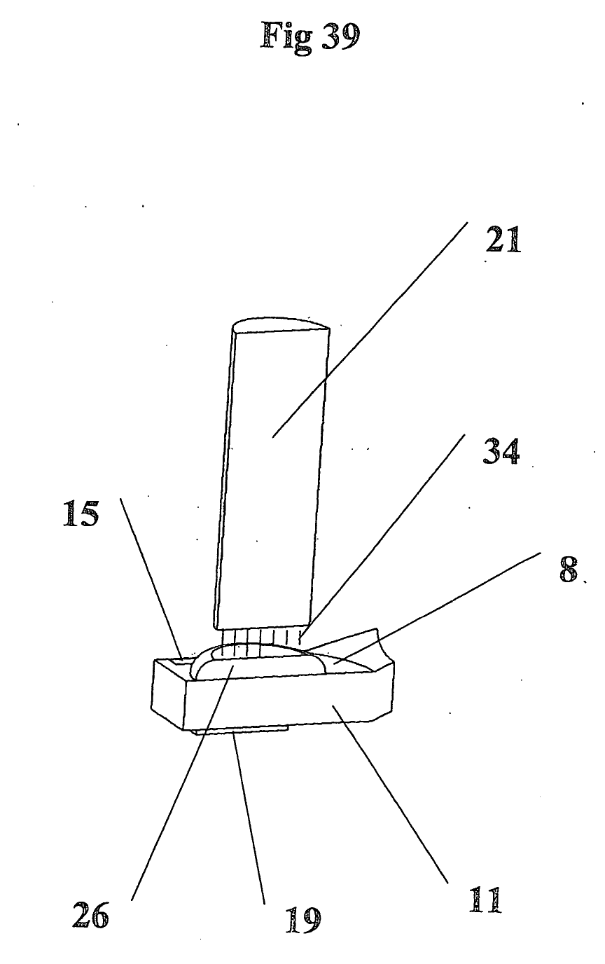

FIG. 39 shows a schematic cross-section of an electric arc between a carbon electrode and the top surface of the front portion of the brazing block and the carbon deposit.

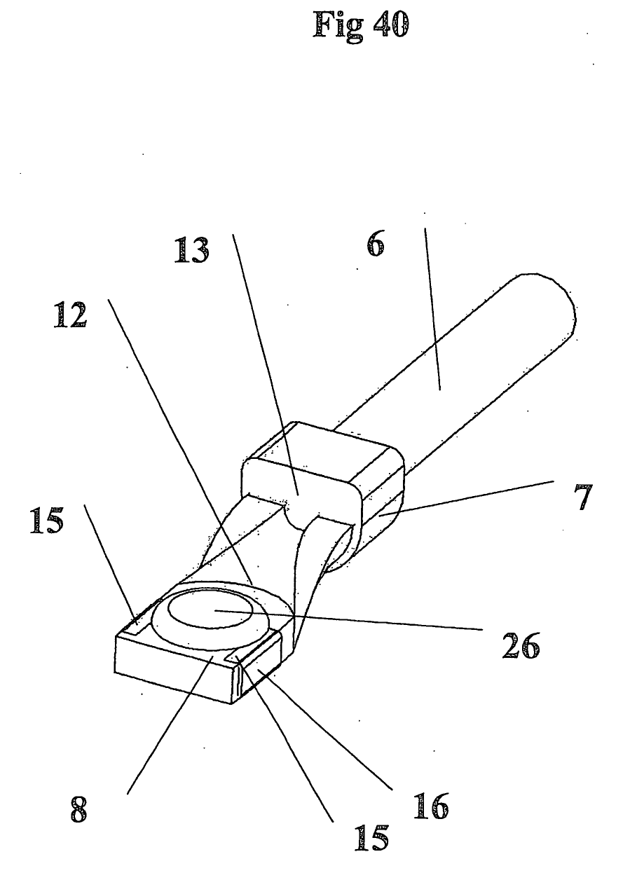

FIG. 40 shows a representation of a cable shoe from above with a carbon layer positioned on the top surface of the front portion of the brazing block.

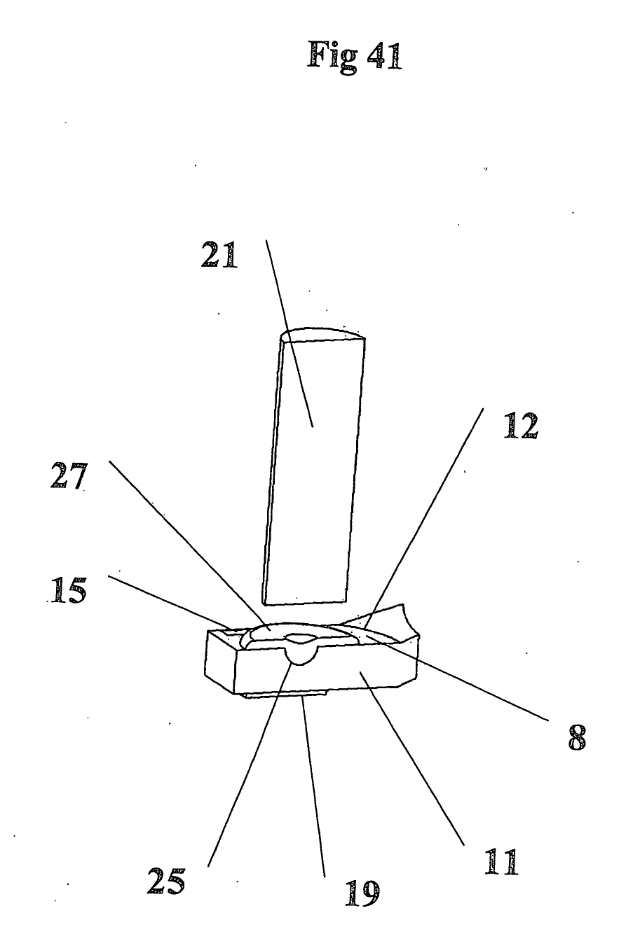

FIG. 41 shows a cross-sectional view of the effect of the cavity on thickness and geometric shape of the deposited carbon layer.

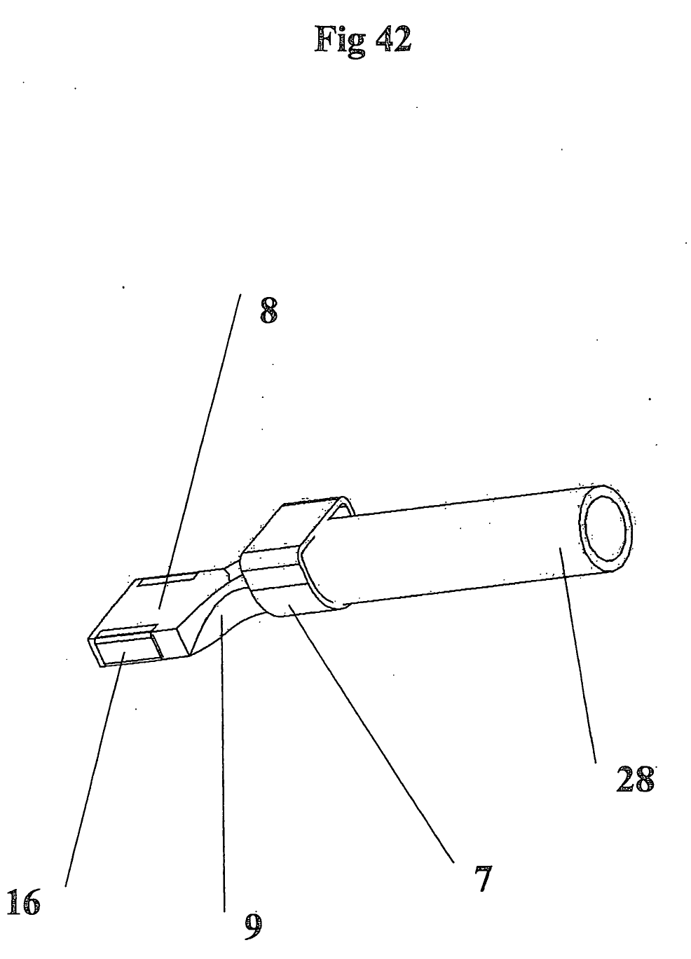

FIG. 42 shows a connecting piece with a connection pipe.

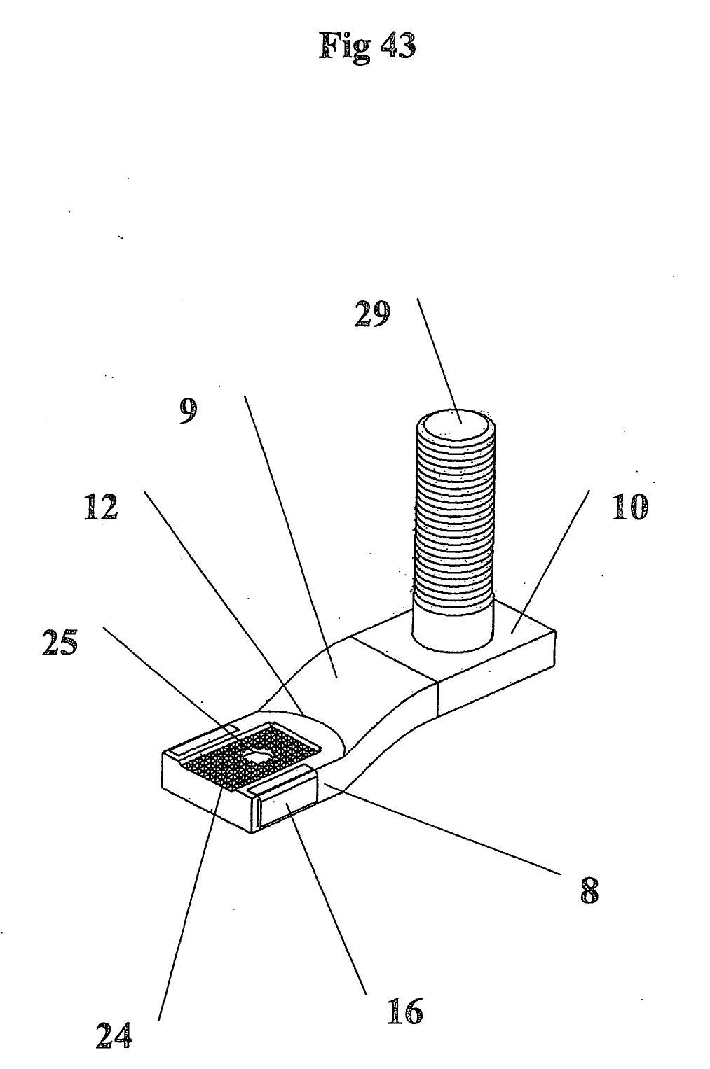

FIG. 43 shows a connecting piece with threaded bolt portion.

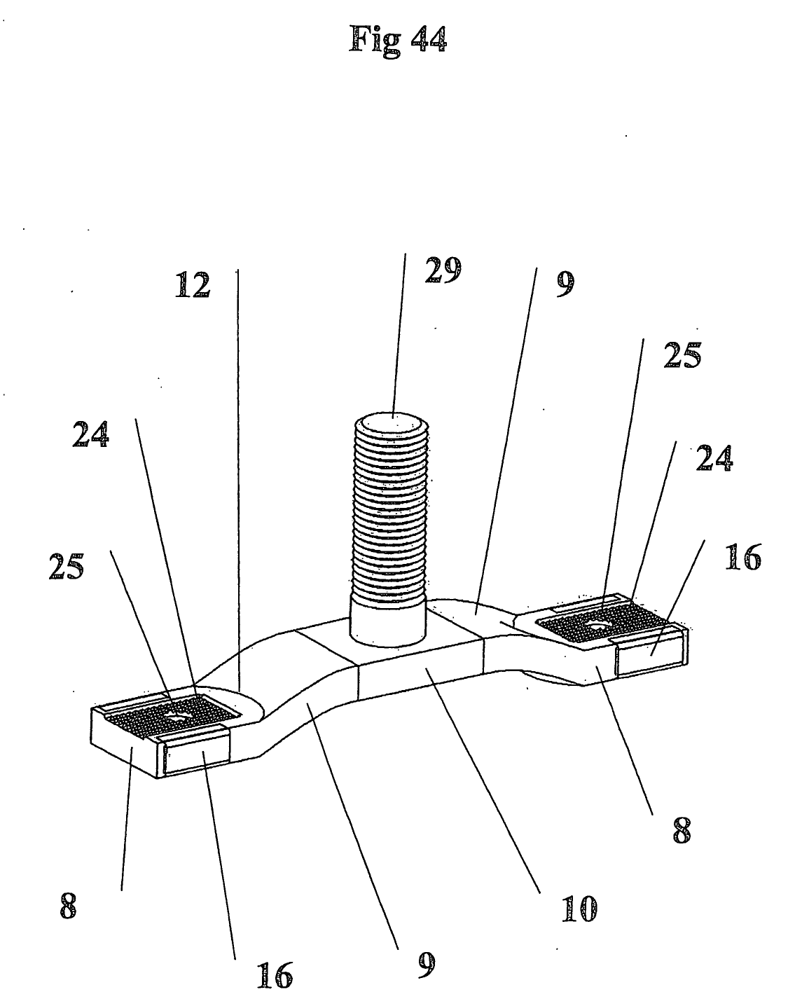

FIG. 44 shows a connecting piece consisting of several brazing blocks with a common end portion and a threaded bolt portion.

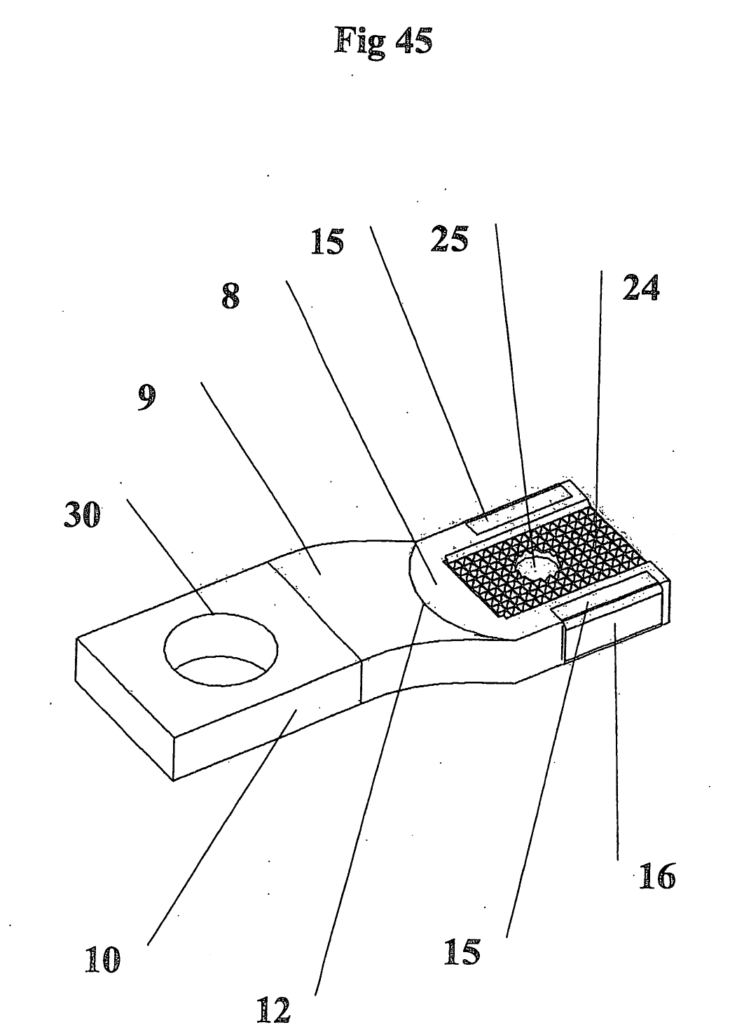

FIG. 45 shows a connecting piece with a connection hole.

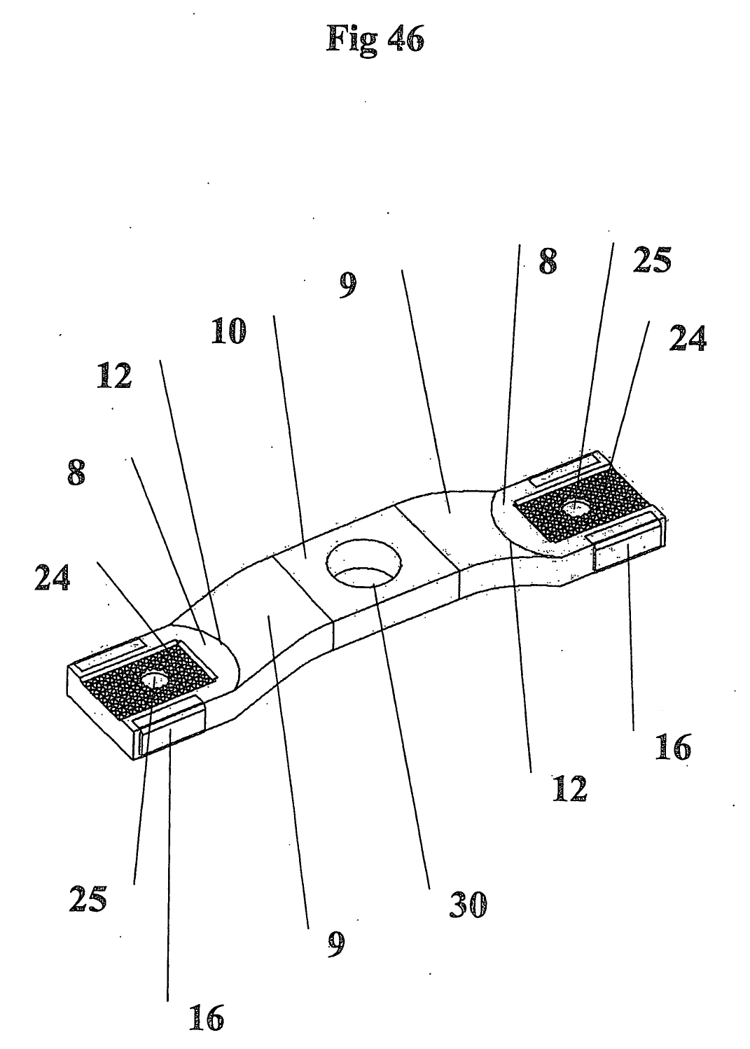

FIG. 46 shows a connecting piece consisting of several brazing blocks with a common end portion and a connection hole.

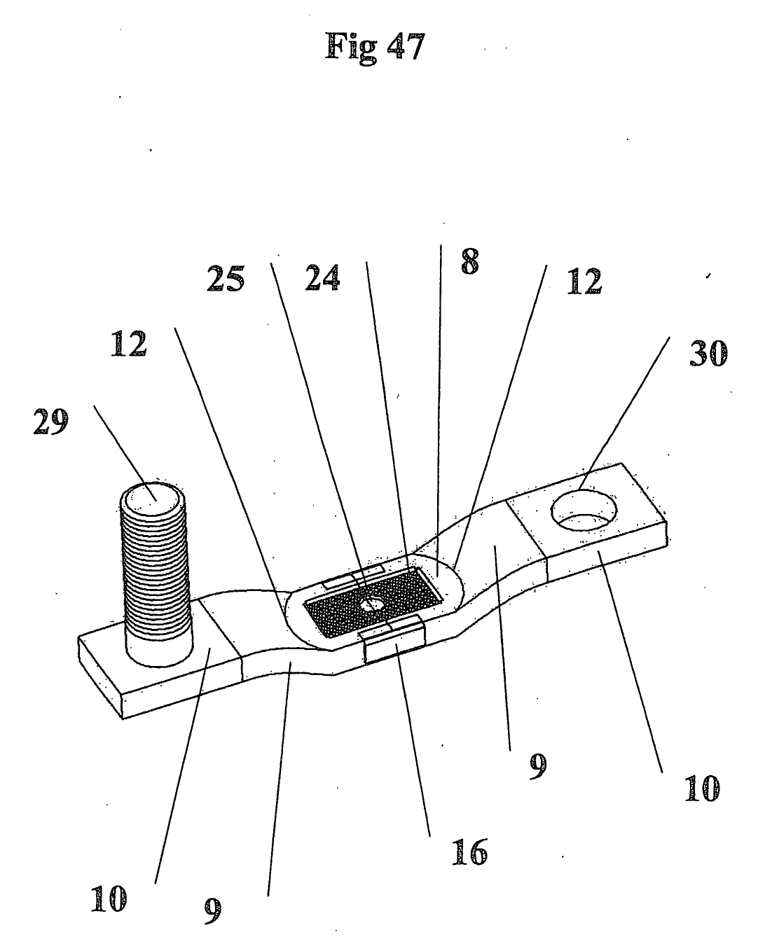

FIG. 47 shows a connecting piece with several brazing blocks with a common front portion, and with a connection hole and a threaded bolt portion.

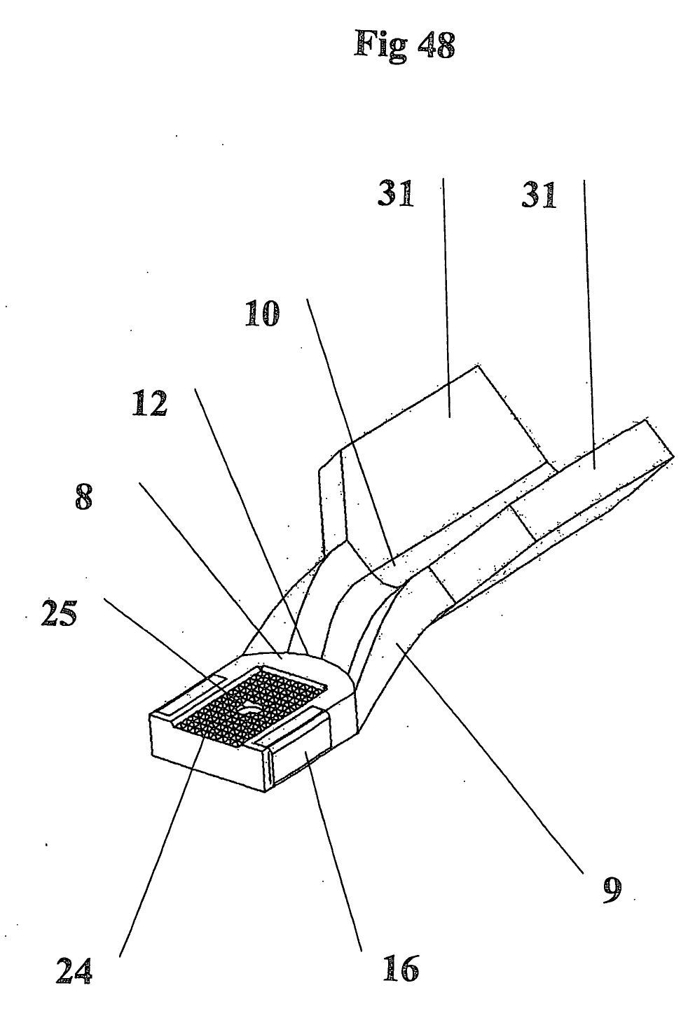

FIG. 48 shows a connecting piece with wings.

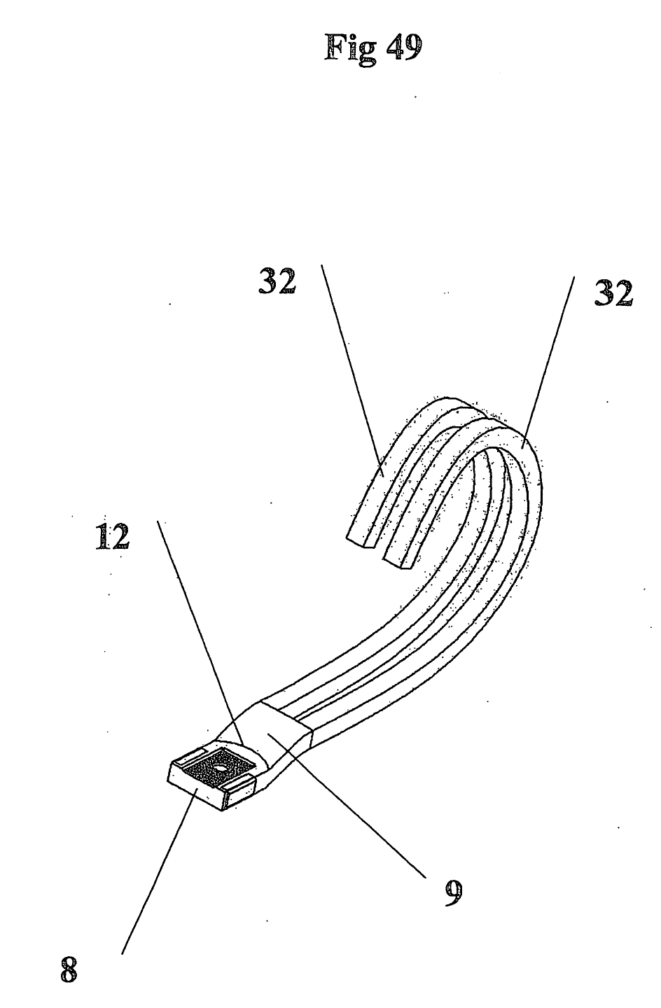

FIG. 49 shows a connecting piece with tongues.

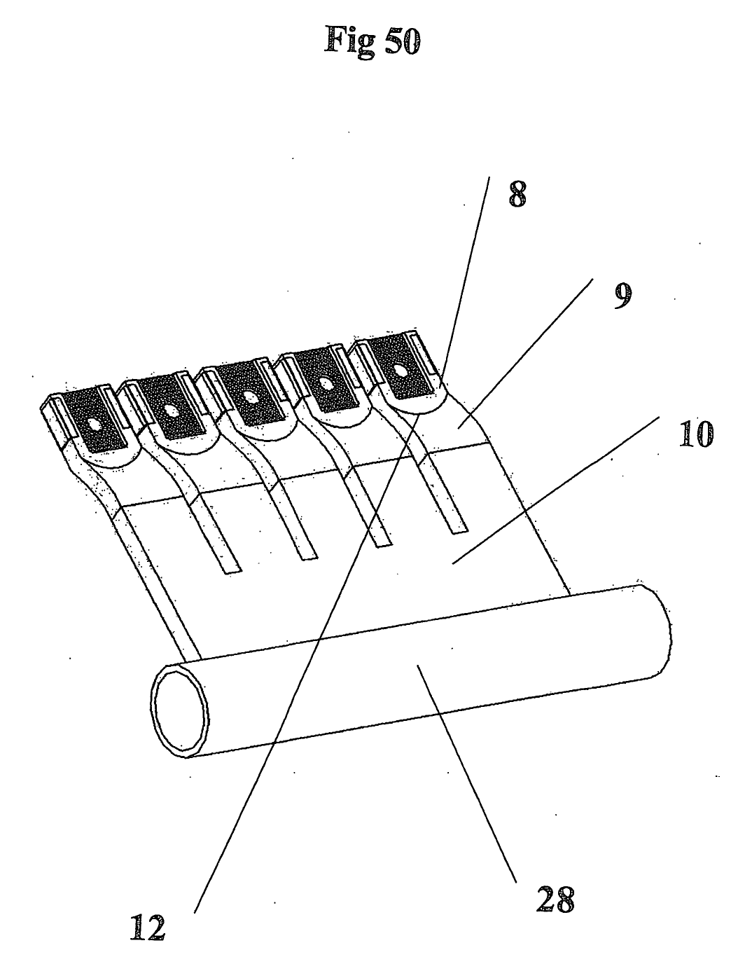

FIG. 50 shows a connecting piece consisting of several brazing blocks with a common end portion and a connection pipe.

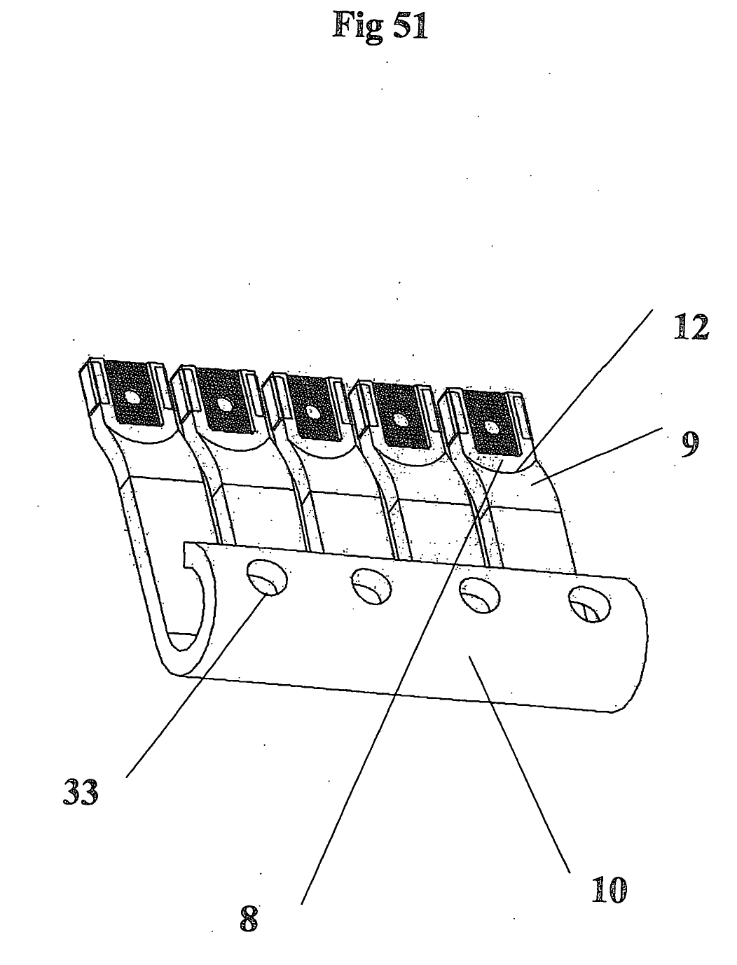

FIG. 51 shows a connecting piece consisting of several brazing blocks with a common end portion provided with mounting holes.

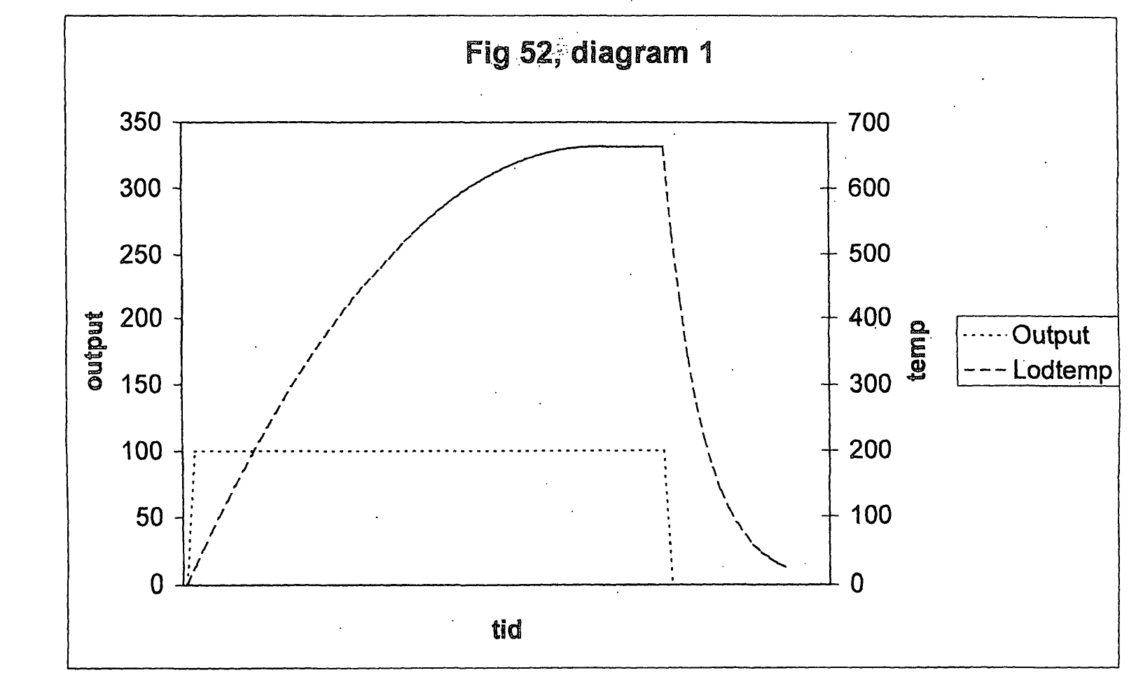

FIG. 52 is a graph 1 showing the current or power, i.e., the output in relation to the time during the brazing process for a formula.

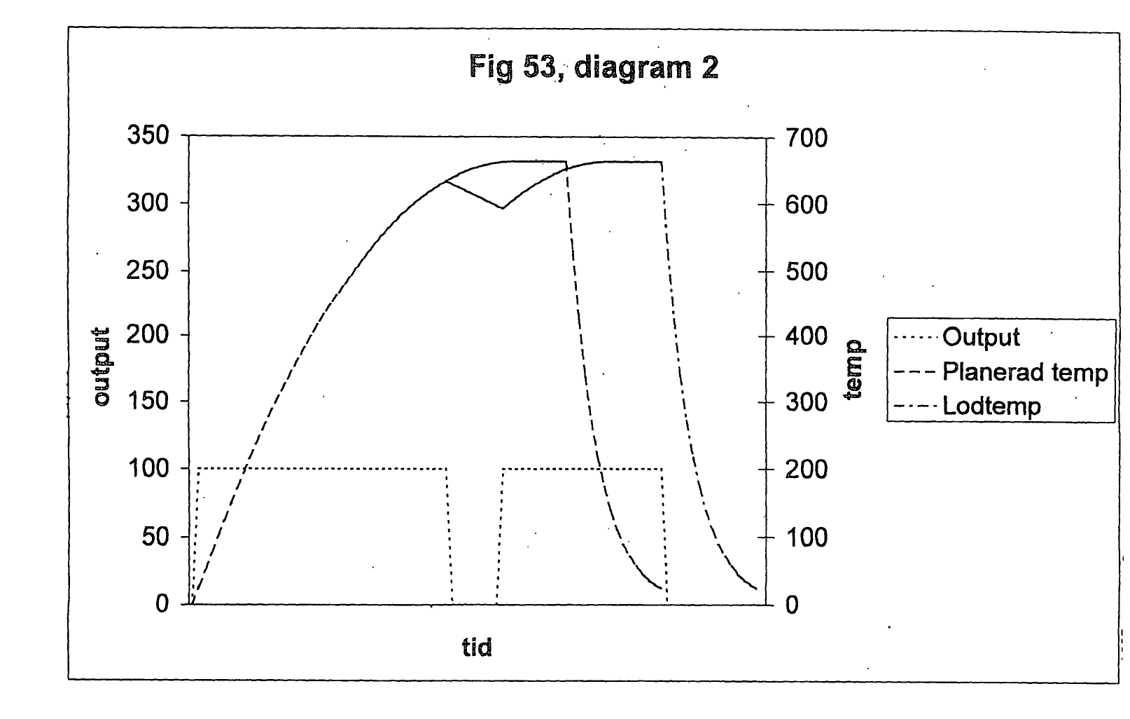

FIG. 53 is a graph 2 for a specific situation.

FIG. 1 shows a schematic overview of some of the components included in the brazing process. It displays a battery 1, which comprises the energy source of the brazing process from which the current passes to an electronics unit 2. The electronics unit 2 receives and processes incoming information and data from the brazing gun 3 via its power-supply circuitry and signal cable 5 and incoming data from the battery 1 via a circuitry. In the electronics unit 2, there are a number of programmed formulas where every formula has unique characteristics for how the current or power, output, should be varied over time for a specific brazing situation. The operator selects a formula, with the aid of a formula selector, which suits this very specific brazing situation adapted to material and conditions required by the brazing situation. The electronics unit 2 also contains a detection and registration device, which provides information about what is happening during the brazing. This information is stored and processed in the electronics unit 2 and is forwarded to the operator after brazing is completed by way of a display and/or sound device. The information can also be stored for retrieval at a later time in electronic or other form via one of the data ports. This acts as an acknowledgement of the result of the brazing. The electronics unit 2 also contains communications ports for connection of external equipment, for example, printers, programming equipment, and data communications equipment. There is also a power and charging port for battery-powered equipment and charging equipment. There is also a formula selector and an alarm-acknowledgement function.

When the power switch on the brazing gun 3 closes an electric circuit, a carbon electrode mounted in the electrode holder will initially short-circuit the circuit against a connecting piece 4 of electrically conductive material, for example, a cable shoe, and afterwards, when the carbon electrode in the brazing gun 3 is lifted from the connecting piece 4, ignites an electric arc 34 which, protected by guard ring(s) will work on the surface of the connecting piece 4. The connecting piece 4 will be brazed onto the workpiece 5.

FIG. 2 shows the components included in an electrically conductive connecting piece 4 excluding the brazing clip. The drawing shows a cable or thread 6 which will be inserted into a pipe 7 from behind, and from the other side a brazing block 11 is inserted, consisting of an end portion 10, a middle portion 9 and a front portion 8. Between the front portion 8 and the middle portion 9 is a semicircular raised edge 12. The drawing shows the main components for manufacturing a type of connecting piece 4 of electrically conductive material, preferably a cable shoe. The end portion 10 of the brazing block 11, its middle portion 9 and its front portion 8 are made from a rectangular original piece which has been compressed.

FIG. 3 shows the components included in an electrically conductive connecting piece 4 excluding the brazing clip where some of the parts are mounted. It displays how the brazing block 11 with its end portion 10 is inserted into the pipe 7 and the cable 6 is on the other side. It also displays the semicircular raised edge 12.

FIG. 4 shows the mounted components included in an electrically conductive connecting piece 4 excluding the brazing clip. First, the end portion 10 of the brazing block 11 has been inserted into the pipe 7, and after that, the cable or thread 6 has been inserted into the same pipe 7, or vice versa. The drawing also shows the semicircular raised edge 12.

FIG. 5 shows the mounted components included in an electrically conductive connecting piece 4 excluding the brazing clip, where a compression of the pipe 7 has been performed, so that it attaches the cable 6 to the brazing block 11. It displays how the cable 6, when the pipe 7 is being compressed, is pressed down into the end portion 10 of the brazing block 11 and partially into its middle portion 9.

FIG. 6 shows the mounted parts included in an electrically conductive connecting piece 4, excluding the brazing clip, where a welding 13 or brazing has been performed on the compressed portion outside the pipe 7. The drawing shows the cable 6, the front portion 8 of the brazing block 11 and the semicircular raised edge 12.

FIG. 7 shows a separately manufactured brazing clip 14 with both side portions 16 and both clamping tabs 15. This brazing clip 14 is manufactured separately and is to be slipped onto the brazing block 11.

FIG. 8 shows an electrically conductive connecting piece 4 in the form of a cable shoe with an unmounted brazing clip 14, showing the cable 6, the compressed pipe 7 with a weld or braze joint 13 and the semicircular raised edge 12. The brazing clip 14, with its side portions 16 and clamping tabs 15, is to be slipped onto the front portion 8 of the brazing block 11.

FIG. 9 shows an electrically conductive connecting piece 4 in the form of a cable shoe with a brazing clip 14 slipped onto the homogeneous front portion 8. It shows the same details as the previous figure.

FIG. 10 shows the base material: a brazing plate 17 for a brazing clip 14 to be manufactured on the front portion 8 of a brazing block 11.

FIG. 11 shows an electrically conductive connecting piece 4 in the form of a cable shoe with all included parts, showing a separate base material, a brazing plate 17 for manufacturing of a brazing clip 14 on the front portion 8 of the brazing block 11.

FIG. 12 shows an electrically conductive connecting piece 4 in the form of a cable shoe with a separate base material, a brazing plate 17 directly below the front portion 8 of the brazing block 11. The other parts of the connecting piece 4 are shown in the drawing.

FIG. 13 shows an electrically conductive connecting piece 4 in the form of a cable shoe with a separate base material, a brazing plate 17 with folded-up short sides 18 around the sides of the front portion 8 of the brazing block 11.

FIG. 14 shows an electrically conductive connecting piece 4 in the form of a cable shoe with a separate base material, a brazing plate 17 with side portions 16 and clamping tabs 15 against the front portion 8 of the brazing block 11. Here, both the side portions 16 and the clamping tabs 15 are located outside the front portion 8 of the brazing block 11. Also shown are the other parts included in the cable shoe.

FIG. 15 shows an electrically conductive connecting piece 4 in the form of a cable shoe with a brazing clip 14 with side portions 16 and clamping tabs 15 pressed into the front portion 8 of the brazing block 11. These clamping tabs 15 are pressed into the material of the front portion 8, for example, copper.

FIG. 16 shows an electrically conductive connecting piece 4 in the form of a cable shoe with a brazing clip 14 with side portions 16 on the surface of the front portion 8 of the brazing block 11, and clamping tabs 15 pressed into the front portion 8 of the brazing block 11. The drawing also shows the underlying middle portion 19 of the brazing clip 14, which portion is located outside the front portion 8. The drawing also shows the other parts of the cable shoe.

FIG. 17 shows the bottom of an electrically conductive connecting piece 4 in the form of a cable shoe with a pressed-on brazing clip 14, showing the brazing clip's 14 underlying, depressed side portions 20 and the underlying middle portion 19 located outside the front portion 8, which middle portion will, at the time of brazing, melt and cover the surface between the bottom of the brazing block 11 and the workpiece 5. The depression of the side portions 20 and the clamping tabs 15 in the front portion 8 provides for good bond strength of the brazing clip 14.

FIG. 18 shows how the completed pressed-on brazing clip 14 looks. It displays the brazing clip's 14 underlying middle portion 19 and underlying depressed side portions 20 and the brazing clip's 14 side portions 16 and the clamping tabs 15.

FIG. 19 is a tilted bottom view of an electrically conductive connecting piece 4 in the form of a cable shoe with a brazing clip 14 and an electrode 21 from a brazing gun 3, showing the brazing clip's 14 underlying middle portion 19 and underlying depressed side portions 20 and the brazing clip's 14 side portions 16 and the weld joint 13, the cable 6 and the compressed pipe 7.

FIG. 20 is a side elevational view of an electrically conductive connecting piece 4 in the form of a cable shoe with a brazing clip 14 and an electrode 21 from a brazing gun 3, and the drawing shows the same parts as the previous figure.

FIG. 21 shows an electrically conductive connecting piece 4 in the form of a cable shoe with a brazing clip 14 with its parts and a semicircular raised edge 12 adapted to a guard ring 22 in the brazing gun 3.

FIG. 22 shows an electrically conductive connecting piece 4 in the form of a cable shoe with a carbon electrode 21 directly against the front portion 8 of the brazing block 11. When a voltage is applied, the carbon electrode 21 and the brazing block 11 will have different polarities. The drawing also shows the brazing clip 14 with its different parts and the weld joint 13, the compressed pipe 7 and the cable 6.

FIG. 23 is a side elevational view of an electrically conductive connecting piece 4 in the form of a cable shoe with a brazing clip 14 and an electrode 21 from a brazing gun 3 and a semicircular raised edge 12 adapted to the guard ring 22. This is where the brazing process starts: the carbon electrode 21 is lifted up and an electric arc 34 is formed. The drawing also shows the other parts.

FIG. 24 is a side elevational view of an electrically conductive connecting piece 4 in the form of a cable shoe with a brazing clip 14 and a carbon electrode 21 together with a guard ring 22 from a brazing gun 3 placed against the semicircular raised edge 12. The brazing clip 14 with its different parts and the other parts of the cable shoe can be observed in the drawing.

FIG. 25 is a top view of the previous drawing, showing clearly how the guard ring 22 fits into the raised guiding edge 12 of the brazing block 11. Because the carbon electrode 21 and the guard ring 22 represent the brazing gun 3, it can be understood that it is easier for the operator to succeed with the brazing.

FIG. 26 shows how the electrically conductive connecting piece 4 in the form of a cable shoe is moved towards a workpiece 5 by the brazing gun 3 via a carbon electrode 21 and a guard ring 22.

FIG. 27 shows how the carbon electrode 21 and the guard ring 22, which are joined with the brazing gun 3, work on an electrically conductive connecting piece 4 and the workpiece 5, brazing and pressing to attach the connecting piece 4 to the workpiece 5. The other parts of the connecting piece 4 can be observed in the drawing.

FIG. 28 shows an electrically conductive connecting piece 4 in the form of a cable shoe to be brazed onto a non-planar workpiece 23. It is important to obtain an evenly thick braze joint between the brazing block 11 and the non-planar workpiece 23 during brazing.

FIG. 29 shows an electrically conductive connecting piece 4 in the form of a cable shoe attached to a non-planar workpiece 23. The brazing block 11 has become soft from the heat of the brazing process and its shape follows the non-planar supporting surface or the workpiece 23 and an evenly thick braze joint has been obtained between the brazing block 11 and the non-planar workpiece 23 during brazing.

FIG. 30 is a view where the brazing gun 3 does not form a 90-degree angle with the supporting surface, the front portion 8 of the brazing block 11. In the brazing gun 3, however, there is a gyro device allowing the guard ring 22 to descend straight onto the front portion 8 of the brazing block 11 and allowing the front portion 8 of the brazing block 11 with the brazing clip's 14 underlying middle portion 19 to descend perpendicularly on the workpiece 5, so that a correct brazing can be performed. The other parts of the cable shoe can be observed in the drawing.

FIG. 31 is the same view but with an angular offset in the other direction. The operator has moved the brazing gun 3 in the other direction without the position of the front portion 8 of the brazing block 11 being affected, thanks to the gyro device in the brazing gun 3.

FIG. 32 is also the same view of an electrically conductive connecting piece 4 in a brazing process where the brazing gun 3 has a normal position of 90 degrees against the front portion 8 of the brazing block 11, thus also against the workpiece 5.

FIG. 33 shows how the filler is melted off asymmetrically during the brazing process, and shows the underlying middle portion 19 of the brazing clip 14 with the filler partially melted. In this case, the right-hand portion in the drawing has melted off first. The connecting piece 4 has tilted in relation to the supporting surface 5. The guard ring 22 allows this tilt thanks to the gyro device in the brazing gun 3. The other parts of the cable shoe can be observed in the drawing.

FIG. 34 shows a completed brazing where the filler has melted completely. That is, the other left-hand portion of the drawing has melted and the front portion 8 of the brazing block 11 now lies flat against the workpiece 5 and a completed brazing is achieved. An evenly thick braze joint has been obtained between the bottom of the front portion 8 of the brazing block 11 and the workpiece 5 during brazing.

FIG. 35 A shows a knurled connecting piece 4 of electrically conductive material, for example, a cable shoe, without a brazing clip 14. The drawing shows a cable 6 and a compressed pipe 7 with a weld or braze joint 13 and a semicircular raised edge 12. On the front portion 8 of the brazing block 11 is a knurling 24. The front portion 8 of the brazing block 11 can also be blasted. The energy feed in the brazing process is reduced by the front portion 8 of the brazing block 11 being knurled and/or blasted. Heat is transferred from an electric arc 34 to a carbon layer on the front portion 8 of the brazing block 11 released from the carbon electrode 21 in the brazing gun 3. Subsequently, the heat descends to the surface of the front portion 8 of the brazing block 11. By the knurling and/or blasting of this surface, or its exposure to other surface-modifying treatment, a larger interfacing surface is obtained, compared to a smooth surface, which results in faster absorption of energy and thus heating of the brazing block 11. The energy feed can thereby be reduced with a maintained result of the brazing.

FIG. 35 B shows a knurled connecting piece 4 in the form of a cable shoe, and a carbon electrode 21 whose surface area is impregnated. The electric arc 34 of the brazing process works on the knurled surface 24 of the brazing block 11, which results in a larger interfacing surface area, thus achieving a faster energy absorption, but the desired temperature is reached and the energy feed during the brazing process can be interrupted earlier. Consequently, the energy feed is conserved and the battery 1 can be used for more brazings before recharge.

FIG. 36 shows the polarisation of the present brazing process with a knurled brazing block 11 of electrically conductive material. Thanks to the knurling 25 and/or blasting or other surface-enlarging treatment, a larger interfacing surface is obtained, as compared to a smooth surface, which results in a faster absorption of energy and consequently heating of the electrically conductive connecting piece 4. Energy feed can thus be reduced without degradation of the brazing outcome. Heat losses through heat conduction are further reduced because of the short brazing duration. The uneven surface results in the electron concentration occurring in local peaks, which facilitates for the electric arc 34 to be ignited and maintained.

FIG. 37 shows a cable shoe with a brazing clip 14 and all their respective included parts. The drawing also shows a cavity 25 on the front portion 8 of the brazing block 11—this is in order to further improve the carbon layer's bond strength to the front portion 8 of the brazing block 11.

FIG. 38 shows variants of the cavities 25 with respect to shape, number and position on the front portion 8 of the brazing block 11. Also visible in the drawing are the brazing clip's 14 side portions 16 and clamping tabs 15 and the weld joint 13, the cable 6 and the compressed pipe 7. The drawing also shows the semicircular raised edge 12.

FIG. 39 shows a schematic cross-section of an electric arc 34 between the carbon electrode 21 and the front portion 8 of the brazing block 11. Via the electric arc 34, material is transported from the carbon electrode 21, which material settles as a carbon layer 26 on the front portion 8 of the brazing block 11. The carbon layer's 26 tendency to come loose from the supporting surface is mainly determined by three factors, namely:

1. The temperature of the supporting surface during the initial phase of the brazing process.

2. The structure and geometric shape of the supporting surface.

3. The thickness of the carbon layer 26.

The tendency to come loose increases when brazing more heavy-duty connections 4, for example, cable shoes of a greater mass where more energy is required to obtain a good brazing. By the use of the knurling or blasting described above, the carbon layer's bond strength is improved. With the appropriate formula together with the above-mentioned knurling/blasting, a high initial temperature can be reached, which has a positive effect on the bond strength.

FIG. 40 shows a picture of a cable shoe from above with a carbon layer 26 located on the front portion 8 of the brazing block 11, and the brazing clip 14 with its side portions 16 and clamping tabs 15 can be seen. The drawing also shows the weld joint 13, the cable 6 and the compressed pipe 7, and the semicircular raised edge 12.

FIG. 41 shows, in a cross-section view, the effect of the cavity on the thickness and geometric shape of the released carbon layer 27. In order to reduce the carbon layer's 27 thickness, the front portion 8 of the brazing block 11 is provided with one or a few cavities 25, adapted in size and shape so that a satisfactory reduction of the carbon layer's 27 thickness in the adjacent area is achieved when the cavity 25 absorbs carbon composition from the ambient environment, which, in other cases would have resulted in a thicker carbon layer 27. The cavity and/or the cavities 25 also act geometrically as anchoring points for the carbon layer 27, which increases the bond strength. The drawing also shows the brazing clip 14 with its underlying middle portion 19 and the clamping tab 15, and the semicircular raised edge 12.

FIG. 42 shows a connecting piece 9 with connection pipe 28 for subsequent mounting of cable 6 or thread.

FIG. 43 shows a connecting piece 9 where the cavity 25 and the knurling 24 are shown, and a threaded bolt portion 29 is fixed with the end portion 10 of the brazing block 8.

FIG. 44 shows a connecting piece 9 consisting of several brazing blocks 8 with a common end portion 10, and a threaded bolt portion 29 fixed onto on the end portion 10.

FIG. 45 shows a connecting piece 9 with a hole 30 made in the end portion 10 of the brazing block 11. One can see the brazing clip 14 with its included parts, and the knurling 24 and the cavity 25.

FIG. 46 shows a connecting piece 9 consisting of several brazing blocks 8 with a common end portion 10 and a connection hole 30 made therein.

FIG. 47 shows a connecting piece 9 with several brazing blocks 11 with a common front portion 8, and a connection hole 30 made in one end portion 10, and in the other end portion 10 a threaded bolt portion 29 is connected.

FIG. 48 shows a connecting piece 9 with wings 31 protruding from the end portion 10.

FIG. 49 shows a connecting piece 9 where the end portion 10 consists of two protruding tongues 32.

FIG. 50 shows a connecting piece 9 consisting of several brazing blocks 8 with a common end portion 10 and a connection pipe 28 for subsequent mounting of one or several threads or cables 6.

FIG. 51 shows a connecting piece 9 consisting of several brazing blocks 8 with a common end portion 10 provided with one or several mounting holes 33.

FIG. 52 is a graph 1 showing the current or power, i.e., output in relation to time during the brazing process of a formula. The output scale of the graph is one of many possible scales depending on the conditions before a brazing. Output indicates an average power in the electric arc 34 and the electrode 21, alternatively delivered average current. A constant output makes the temperature rise and level out on the desired value. The output values are chosen to reach a stable final temperature in the brazing. The filler's melting point is about 650 degrees Celsius. When the temperature exceeds 720 degrees Celsius in steel that subsequently cools off fast, martensite is formed. “Filler temp” indicates the brazing clip's 14 temperature on the bottom of the connecting piece 4. The time is very short and depends on the working material, heat losses, filler material, etc.

FIG. 53 is a graph 2 depicting a specific situation. Graph 2 of the drawing shows the result of an output interruption. The temperature curve “Planned temp” equals the one shown in FIG. 52 for graph 1. If, for some reason, the electric arc 34 is now extinguished during the brazing process, the output will be interrupted, which is detected by the electronics unit 2. The electrode 21 is then lowered towards the surface of the front portion 8 of the brazing block 11, whereupon it is lifted anew and the electric arc 34 is restarted. This procedure is repeated a number of times until the electric arc 34 is ignited. Graph 2 of the drawing shows an output interruption with a corresponding fall in temperature. When output is resumed, the brazing is completed. The total time is prolonged, owing both to the actual time loss during the interruption, and to the compensation for the fall in temperature during the interruption. This interrupt procedure prevents loss of material and energy that would be the result of a failed, interrupted brazing. Furthermore, the additional work effort of removing the connection 4 and re-grinding the base material is avoided.

The principles of the present invention are a new method to manufacture a new type of connecting piece of electrically conductive material which can use all types of cables or thread of small as well as large diameter in a temperature-controlled brazing process, obtaining a brazing which, under the braze joint after the brazing, is free from martensite. With the present invention, one should also increase the bond strength of the carbon layer on the connecting piece by knurling and/or blasting the connecting piece and providing it with one or a few cavities, which comprise anchoring points for the carbon layer and also drain the carbon layer to a thinner layer. This enables a more secure brazing, and by regulating and controlling current and power, one can save energy, time and material, and reduce the number of failed brazings. Furthermore, it is possible to better secure the brazing clip to a connecting piece, for example, a cable shoe, so that it does not easily come off the cable shoe when handled by the operator and during transportation, and to obtain an evenly thick braze joint between the cable shoe and the workpiece when brazing according to the new brazing process.

The drawings show only some embodiments of the invention, but it should be noted that it can be designed in many different ways within the scope of the subsequent claims.

1. A method of manufacturing a new type of connecting piece of electrically conductive material, preferably a cable shoe, holder or connection device, which is to be joined with another object of electrically conductive material using a brazing process without residual detrimental martensite structure in the object under the braze joint, characterised in that a homogeneous body consisting of front portion (8), middle portion (9) and end portion (10), is formed into a brazing block (11), which, in its front portion (8) is compressed by a brazing clip (14) to comprise a joint part, the brazing clip (14) consisting of two underlying parts (20) and two clamping tabs (15) which are pressed into the front portion (8) of brazing block (11) and also an underlying middle portion (19) and two side portions (16) outside the front portion (8) of the brazing block (11) and the brazing clip (14) being oriented in a transversal direction with respect to the brazing block (11), and the middle portion (9) being formed so that a semicircular raised guiding edge (12) of a shape adapted to a guard ring (22) attached during the brazing process is formed in connection with the front portion (8), and the surface of the front portion (8) of the brazing block being superficially modified by blasting, knurling and/or with cavities, or other surface-modifying measure, and the end portion (10) of the brazing block (11) being formed to a co-operating part, and the brazing block (11) alone or joined in appropriate constellations using, for example, pressing, brazing, riveting, drilling or welding with other co-operating parts such as rings, pipes, threaded bolt parts, holes, wings, tongues, hooks or other brazing-block parts, as well as cables or threads, comprising a connecting piece (4), for example, cable shoe, holder or connection device.

2. A connecting piece of electrically conductive material, preferably a cable shoe, a holder or a connection device, which is to be joined with another object of electrically conductive material using a brazing process without residual detrimental martensite structure in this other object, characterised in that the connecting piece's joint part consists of a homogeneous brazing block (11) consisting of front portion (8), middle portion (9) and end portion (10), and a secured brazing clip (14) encompassing the front portion (8) and partially pressed into the top side, at least the top side of the front portion (8) of the brazing block (11) having had its surface enlarged by blasting and/or knurling (24) or other surface-modifying measure so that the heat-absorption capability of the front portion (8) from the electric arc (34) manipulating the surface and the carbon deposit (26) formed on the surface by the carbon electrode has increased, which thereby enables a rapid initial increase in temperature in the surface layer during the brazing process the surface layer, resulting in a more secure connection between the carbon layer (26) and the top side of the front portion (8), a rapid initial increase in temperature in the front portion (8) and in the brazing clip (14), resulting in a reduction of oxidation interference before the braze joint has been formed, and a relative reduction in cooling effect, mainly by heat conduction partially because of a changed ratio of surface to mass, partially because of the fact that the matter diverting the heat does not reach the higher temperatures at which the heat conductivity of the substance increases, which factors thereby together enable a dimensional increase of the connecting piece (4) and a relative reduction of the energy necessary for the brazing process, and the local ridges and peaks functioning to concentrate electrons or electron holes to facilitate the ignition and maintaining of an electric arc (34) between the joint part and the carbon electrode (21), and cavities (25) made in the surface draining and reducing the thickness of the carbon deposit (26) and comprising anchoring points for the carbon deposit (26).

3. A connecting piece of electrically conductive material according to claim 2, characterised in that the brazing clip (14) is formed from a piece of sheet metal not being hole-punched, and both overlying clamping tabs (15) of the brazing clip (14) being pressed into the top surface of the front portion (8) of the brazing block (11) while the side portions (20) of the bottom surface of the brazing clip (14) have been pressed into the brazing block, and no flux exists between the brazing block and the brazing clip, and corners and short sides (16) of the brazing clip not protruding outside the body of the brazing block (11).

4. A connecting piece of electrically conductive material according to claim 2, characterised in that the end portion (10) of the brazing block (11) of the joint part is shaped to fit into a pipe portion (7), that a cable or thread (6), together with the joint part, are inserted into a pipe portion (7) that is being compressed, and that the compression joint is being brazed or welded.

5. Connecting piece of electrically conductive material according to claim 2, characterised in that the front portion (8) of the brazing block (11) of the joint part is dimensioned to allow for modification of its shape according to the workpiece 5 using available pressure from the guard ring (22) together with the reached temperature, thereby accomplishing an evenly thick braze joint.

6. A connecting piece of electrically conductive material according to claim 2, characterised in that the end portion (10) of the brazing block of the joint part is shaped for and joined with a connection pipe (28), intended to subsequently receive in its other end a cable or thread (6).

7. A connecting piece of electrically conductive material according to claim 2, characterised in that the end portion (10) of the brazing block (11) of the joint part is shaped with a connection where one or several threaded bolt portions are secured.

8. A connecting piece of electrically conductive material according to claim 2, characterised in that the end portion (10) of the brazing block (11) of the joint part is directly or indirectly joined with one or several other connecting pieces (4).

9. A connecting piece of electrically conductive material according to claim 2, characterised in that the end portion (10) of the brazing block (11) of the joint part is provided with one or several tongues which are folded and pressed around or support optional elements.

10. A connecting piece of electrically conductive material according to claim 2, characterised in that the end portion (10) of the brazing block (11) of the joint part is provided with side wings which are folded and pressed around a cable or thread (6), whereupon the compression joint is being brazed or welded.

11. A connecting piece of electrically conductive material according to claim 2, characterised in that the end portion (10) of the brazing block (11) of the joint part is provided with one or several mounting holes (33).

12. A connecting piece of electrically conductive material according to claim 2, characterised in that the front portion (8) of the brazing block (11) of the joint part is common to one or several brazing blocks (11).
